(19) United States
(12) Patent Application Publication
(10) Pub. No.: US 2018/0349915 A1
(43) Pub. Date: Dec. 6, 2018

(54) INFORMATION PROCESSING SYSTEM, METHOD AND NON-TRANSITORY COMPUTER-READABLE STORAGE MEDIUM

(71) Applicant: FUJITSU LIMITED, Kawasaki-shi (JP)

(72) Inventors: Kenichi TAKAYANAGI, Kawasaki-shi (JP); Shigeaki Koike, Kawasaki (JP); Naoyuki Yoshimi, Kawasaki (JP)

(73) Assignee: FUJITSU LIMITED, Kawasaki-shi (JP)

(21) Appl. No.: 15/989,684

(22) Filed: May 25, 2018

(30) Foreign Application Priority Data
May 30, 2017 (JP) 2017-106730

(51) Int. Cl. G06Q 30/00; G06F 11/07; G06F 21/60

(52) U.S. Cl. CPC G06Q 30/012; G06F 11/0751; G06F 21/602; G06F 11/079; G06F 11/0772

(57) ABSTRACT

An information processing system configured to manage a computer executing a first operating system, the information processing system is configured to receive a request signal that requests information related to software installed on the first operating system, obtain, from the first operating system, a log of a message generated in execution of the software and a first identifier identifying the first operating system, obtain a second identifier for identifying a second operating system on which support target software of a support contract is installed, execute a first determination which determines whether the first identifier and the second identifier coincide with each other, execute a second determination which determines whether the message indicates occurrence of a failure based on the log, and determine whether support for the software is included in a scope of the support contract.

### CROSS-REFERENCE TO RELATED APPLICATION

This application is based upon and claims the benefit of priority of the prior Japanese Patent Application No. 2017-106730, filed on May 30, 2017, the entire contents of which are incorporated herein by reference.

### FIELD

The embodiments discussed herein are related to an information processing system, a method and a non-transitory computer-readable storage medium.

### BACKGROUND

Various problems occur when a company operates a computer system. The problems occur due to various causes including a mistake in setting of an apparatus and a software bug. It is therefore difficult for the company to deal independently and promptly with all of problems that occur. Accordingly, there is a service supporting the operation of the computer system.

Support for the operation of the computer system includes hardware support and software support. Software support is performed only for a product sold normally. Software is ease to copy illegally. Thus, an identification number for individual identification, for example, is set to the software. When support is performed for the software, conditions of operation of the specific software are examined via a network based on the identification number, and it is confirmed that the software is used within a scope of a usage license of the software. Then, the support for the software is performed.

As a technology that assists in the software support, there is, for example, an information managing device capable of managing a software identification tag properly. There is also a software license managing system for reducing a load of license management. Further, there is a method of tracking a distributable software application. Related art documents include Japanese Laid-open Patent Publication No. 2016-181091, Japanese Laid-open Patent Publication No. 2006-338183, and Japanese Laid-open Patent Publication No. 2001-202250.

### SUMMARY

According to an aspect of the embodiments, an information processing system configured to manage a computer executing a first operating system, the information processing system includes at least one memory, and at least one processor coupled to the at least one memory and configured to receive a request signal that requests information related to software installed on the first operating system, obtain, from the first operating system in response to the request signal, a log of a message generated in execution of the software and a first identifier identifying the first operating system, obtain a second identifier for identifying a second operating system on which support target software of a support contract is installed, execute a first determination which determines whether the first identifier and the second identifier coincide with each other, execute a second determination which determines whether the message indicates occurrence of a failure based on the log, and determine whether support for the software is included in a scope of the support contract based on a result of the first determination and a result of the second determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a first embodiment;

FIG. 2 is a diagram illustrating an example of a system configuration of a second embodiment;

FIG. 3 is a diagram illustrating an example of hardware of a computer used in the second embodiment;

FIG. 4 is a block diagram illustrating an example of functions of respective devices in the second embodiment;

FIG. 5 is a diagram illustrating an example of a registry;

FIG. 6 is a diagram illustrating an example of an operating system (OS) information database;

FIG. 7 is a diagram illustrating an example of a support contract information database;

FIG. 8 is a diagram illustrating an example of a state before software installation;

FIG. 9 is a diagram illustrating an example of a state after software installation and conclusion of a support contract;

FIG. 10 is a first diagram illustrating an example of conditions of registration of OS information into a managing server;

FIG. 11 is a second diagram illustrating an example of conditions of registration of OS information into a managing server;

FIG. 12 is a third diagram illustrating an example of conditions of registration of OS information into a managing server;

FIG. 13 is a diagram illustrating an example of conditions of installation of software after registration into a managing server;

FIG. 14 is a diagram illustrating an example of conditions of periodic obtainment of an installation presence or absence flag;

FIG. 15 is a diagram illustrating an example of a state after software installations corresponding in number to the number of licenses;

FIG. 16 is a diagram illustrating an example of conditions of changing an Internet Protocol (IP) address;

FIG. 17 is a first diagram illustrating an example of a support request;

FIG. 18 is a second diagram illustrating an example of a support request;

FIG. 19 is a diagram illustrating an example of dealing with a case where a problem occurs in software as a support contract target;

FIG. 20 is a diagram illustrating an example of dealing with a case where a problem occurs in different software from a support contract target;

FIG. 21 is a diagram illustrating an example of dealing with a case where a problem occurs in more pieces of software than targets of support contracts;

FIG. 22 is a diagram illustrating an example of dealing with a case where a false OS management number is notified to receive support;

FIG. 23 is a diagram illustrating an example of an operation state before a virtual machine is copied;

FIG. 24 is a diagram illustrating an example of a state after a virtual machine is copied;

FIG. 25 is a diagram illustrating an example of conditions of periodic update of an OS management key;

FIG. 26 is a first diagram illustrating an example of conditions of registration of other OS information in a case where OS information is already registered;

FIG. 27 is a second diagram illustrating an example of conditions of registration of other OS information in a case where OS information is already registered;

FIG. 28 is a diagram illustrating an example of conditions of periodic update of OS management keys after power to a server including an OS as a copy source is shut off;

FIG. 29 is a first diagram illustrating an example of conditions of update of OS management keys, update accompanying registration of OS information after shutting off power to a server including an OS as a copy source;

FIG. 30 is a second diagram illustrating an example of conditions of update of OS management keys, update accompanying registration of OS information after shutting off power to a server including an OS as a copy source;

FIG. 31 is a diagram illustrating an example of conditions of periodic update of OS management keys after assignment of registered OS information to an OS as a copy destination;

FIG. 32 is a first diagram illustrating an example of conditions of registration of OS information after a restart of an OS as a copy source;

FIG. 33 is a second diagram illustrating an example of conditions of registration of OS information after a restart of an OS as a copy source;

FIG. 34 is a sequence diagram illustrating a first half of a procedure of OS information registration processing;

FIGS. 35A and 35B are a sequence diagram illustrating a second half of a procedure of OS information registration processing;

FIG. 36 is a sequence diagram illustrating an example of a procedure of installation information periodic obtainment processing;

FIG. 37 is a sequence diagram illustrating an example of a procedure of OS management key periodic update processing;

FIG. 38 is a flowchart illustrating an example of a procedure of OS management number identification processing;

FIG. 39 is a flowchart illustrating an example of a procedure of encrypted file generation processing; and

FIGS. 40A and 40B are a flowchart illustrating an example of a procedure of support contract confirmation processing.

### DESCRIPTION OF EMBODIMENTS

Advanced support service for software is provided only to customers that have entered into a service contract. The service contract is made for each piece of software individually. When the software has an individual identification number, the software as a target of the service contracted may be identified by the individual identification number.

On the other hand, there is a case of providing support service targeted for software that does not have an identification number for individual identification. When there are a plurality of pieces of software not having any individual identification number, it is difficult to determine whether a support contract is concluded for each of the plurality of pieces of software. Therefore a customer may use one support service for a plurality of pieces of software. For example, a customer is assumed who has purchased ten pieces of software of a same kind, and entered into a support contract only for one of the ten pieces of software. When receiving an inquiry about support for a trouble from this customer, a support service provider side does not have measure for confirming whether software causing the trouble is software as a target of the support. Therefore, using the support contract for one piece of software, the customer may receive support for other arbitrary software.

### First Embodiment

A first embodiment will be described. The first embodiment makes it possible to determine properly whether or not support target software is a target of a support contract even when the support target software is operating on a virtual machine. The virtual machine is a computer system constructed on a computer in a pseudo manner.

First, description will be made of a difficulty in managing a support contract for software not having an individual identification number in a case where the software is executed on a virtual machine.

A recent computer system is operated with a plurality of virtual machines operated on one computer. In this case, identifying the individual identification number of hardware executing software does not mean that the individual software is identified. Moreover, a virtual machine may move on a plurality of pieces of hardware by performing migration. For example, in a case where software is installed on an OS on a virtual machine, correspondence relation between the software and hardware changes dynamically. It is therefore difficult to perform individual identification of software executed on a virtual machine by using the individual information of hardware executing the software.

On the other hand, a support contract for software is made for each piece of software individually. It is therefore important to be able to perform individual identification of the software to identify the target of the support contract. In addition, it is difficult to use the identification information of hardware executing the software for the individual identification of the software, as described above. As a result, in a case where software not having an individual identification number is executed on a virtual machine, it is difficult to manage the support contract for the software.

Incidentally, the following problem occurs when the individual identification of software as a target of a support contract is not performed properly.

For example, when the individual identification of software is not performed properly, and a user makes contact for a support request, there is a possibility that the user communicates wrong information to the support. It is difficult for a person in charge of support who receives the wrong information to provide an appropriate support service.

In addition, when the individual identification of the software is not performed properly, even in a case where the user intentionally communicates information different from a fact to the person in charge of support, it is difficult for the person in charge of support to determine whether the communicated information is correct or not. As a result, even when the support request is for software not covered by the support, it is difficult for the person in charge of support to refuse the request, and the person in charge of support provides the support service. Then, the user may receive the support by making a false claim that the support contract is made for the software, which is not a target of the support contract.

Accordingly, in the first embodiment, an OS management number is set to an OS operating on a virtual machine, and individual identification of software is made possible by the OS management number of the OS on which software is installed.

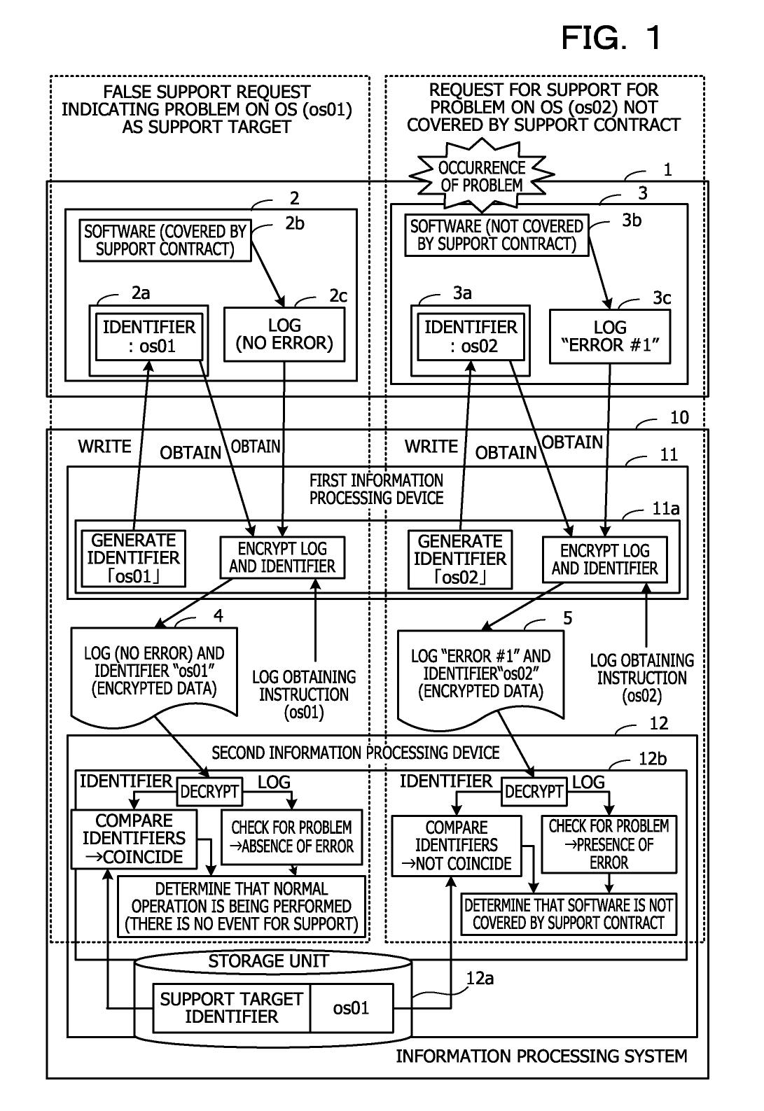

FIG. 1 is a diagram illustrating an example of a configuration of the first embodiment. An information processing system 10 is coupled to a management target computer 1 via a network, for example. The management target computer 1 may start a plurality of virtual machines using a hypervisor, for example, and execute OSes 2 and 3 on the plurality of virtual machines individually.

The OS 2 includes a registry 2a. The registry 2a is an example of a storage area for setting information of the OS 2. In addition, software 2b is installed on the OS 2. In the example of FIG. 1, the software 2b is a target of support service based on a support contract. A message output in a process of execution of the software 2b by the OS 2 is recorded as a log 2c.

The OS 3 includes a registry 3a. In addition, software 3b is installed on the OS 3. In the example of FIG. 1, the software 3b is not a target of the support service based on the support contract. A message output in a process of execution of the software 3b by the OS 3 is recorded as a log 3c.

The information processing system 10 includes a first information processing device 11 and a second information processing device 12. The first information processing device 11 includes a processing unit 11a. The processing unit 11a is, for example, a processor or an arithmetic circuit possessed by the first information processing device 11. The second information processing device 12 includes a storage unit 12a and a processing unit 12b. The storage unit 12a is, for example, a memory or a storage device possessed by the second information processing device 12. The processing unit 12b is, for example, a processor or an arithmetic circuit possessed by the second information processing device 12.

Processing to be performed by the first information processing device 11 in a support contract managing method to be described in the following may be implemented by making the processing unit 11a of the first information processing device 11 execute a managing program for the first information processing device 11, for example. In addition, processing to be performed by the second information processing device 12 in the support contract managing method to be described in the following may be implemented by making the processing unit 12b of the second information processing device 12 execute a managing program for the second information processing device 12, for example.

The processing unit 11a of the first information processing device 11 writes identifiers corresponding to a plurality of the respective OSes 2 and 3 executed on the management target computer 1 to the registries 2a and 3a of the plurality of respective OSes 2 and 3. For example, the processing unit 11a generates identifiers that may uniquely identify the plurality of respective OSes 2 and 3, and writes the generated identifiers to the registries 2a and 3a of the plurality of respective OSes 2 and 3.

In addition, in response to a log obtaining instruction related to the software executed on one of the OSes, the processing unit 11a obtains, from the OS, the log of a message output in a process of execution of the software and the identifier stored in the registry of the OS. The processing unit 11a then outputs a file including the obtained log and the obtained identifier. For example, when a log obtaining instruction related to the software 2b on the OS 2 is input, the processing unit 11a obtains the identifier from the registry 2a of the OS 2, and obtains the log 2c of the software 2b. The processing unit 11a then outputs a file 4 including the obtained identifier and the obtained log. In addition, when a log obtaining instruction related to the software 3b on the OS 3 is input, the processing unit 11a obtains the identifier from the registry 3a of the OS 3, and obtains the log 3c of the software 3b. The processing unit 11a then outputs a file 5 including the obtained identifier and the obtained log. Incidentally, the processing unit 11a may generate encrypted data obtained by encrypting the logs and the identifiers, and output the files 4 and 5 including the encrypted data.

The storage unit 12a of the second information processing device 12 stores a support target identifier indicating the OS on which the software as the support target of the support contract is installed. The processing unit 12b of the second information processing device 12 obtains the files 4 and 5 output by the first information processing device 11. Next, the processing unit 12b extracts the logs and the identifiers from the files 4 and 5. In the case where the logs and the identifiers in the files 4 and 5 are encrypted, the processing unit 12b decrypts the encrypted data in the files 4 and 5, and extracts the logs and the identifiers from a result of the decryption.

The processing unit 12b further determines whether or not the support target identifier coincides with one of the identifiers included in the files 4 and 5 and whether or not the logs included in the files 4 and 5 include a message indicating the occurrence of a problem. Based on a result of these determinations, the processing unit 12b determines whether or not support for the software based on the logs included in the files 4 and 5 is a target of application of the support contract. For example, when the support target identifier coincides with one of the obtained identifiers, and a message indicating the occurrence of a problem is included in the log, the processing unit 12b determines that support for the software based on the log is included in the support contract.

Incidentally, in the support contract, support contracts for a plurality of pieces of software may be concluded. In this case, the storage unit 12a may store support target identifiers corresponding in number to the number of pieces of software as a support target (number of pieces of support target software) defined in the support contracts. Accordingly, when the support target identifier coinciding with the identifier included in the file 4 is not stored in the storage unit 12a, the processing unit 12b determines whether or not the number of support target identifiers stored by the storage unit 12a has reached the number of pieces of support target software. When the number of support target identifiers is less than the number of pieces of support target software, the processing unit 12b stores the obtained identifier as a support target identifier in the storage unit 12a, and determines that the support target identifier and one identifier coincide with each other.

According to such an information processing system 10, even when software not having an individual identifier is executed by an OS on a virtual machine, it is possible to determine correctly whether support for a problem in the software is within a scope of application of a support contract. For example, suppose that a problem has occurred in the software 3b executed on the OS 3. It is to be noted that only the software 2b is a target of application of the support contract, and that the software 3b is excluded from the application of the support contract.

The following description will first be made of a case where a user using the management target computer 1 requests support for the software 3b from a person in charge of support service. The user inputs a log obtaining instruction specifying the OS 3 (identifier “os02”) to the first information processing device 11. Then, the processing unit 11a of the first information processing device 11 obtains the identifier “os02” from the registry 3a within the OS 3, and obtains the log 3c. The log 3c includes an error message “error #1” indicating the content of a problem occurring in the software 3b. The processing unit 11a encrypts the obtained log 3c and the obtained identifier “os02,” and outputs the file 5 including the encrypted data. The user sends the file 5 output from the processing unit 11a to the person in charge of support, and requests support for the problem.

The person in charge of support inputs the received file 5 to the second information processing device 12. The processing unit 12b of the second information processing device 12 decrypts the encrypted data within the file 5, and extracts the log 3c and the identifier “os02” from a result of the decryption. Next, the processing unit 12b compares the obtained identifier “os02” with the support target identifier “os01” within the storage unit 12a. In the example of FIG. 1, it is determined as a result of the comparison that the obtained identifier “os02” and the support target identifier “os01” within the storage unit 12a do not coincide with each other. In addition, the processing unit 12b determines whether or not information (error message) indicating a problem is included within the log 3c. In the example of FIG. 1, an error message is included. In this case, because of the noncoincidence as a result of the comparison of the identifiers, the processing unit 12b determines that the software 3b is excluded from the scope of application of the support contract, and outputs the determination result. The person in charge of support informs the user that support is not to be provided based on the determination result.

Thus, the person in charge of support does not need to provide support for the problem in the software excluded from the scope of application of the support contract.

Description will next be made of a case where the user requests support from the person in charge of support by falsely stating that a problem occurring in the software 3b is occurring in the software 2b as a target of application of the support contract. In this case, the user, for example, explains the content of the problem occurring in the software 3b to the person in charge of support, and informs the person in charge of support that the OS 2 (identifier “os01”) is executing the software causing the problem.

Then, the user inputs a log obtaining instruction specifying the OS 2 (identifier “os01”) to the first information processing device 11. Then, the processing unit 11a of the first information processing device 11 obtains the identifier “os01” from the registry 2a within the OS 2, and obtains the log 2c. The log 2c does not include any error message. The processing unit 11a encrypts the obtained log 2c and the obtained identifier “os01,” and outputs the file 4 including the encrypted data. The user sends the file 4 output from the processing unit 11a to the person in charge of support, and requests support for the problem.

The person in charge of support inputs the received file 4 to the second information processing device 12. The processing unit 12b of the second information processing device 12 decrypts the encrypted data within the file 4, and extracts the log 2c and the identifier “os01” from a result of the decryption. The processing unit 12b next compares the obtained identifier “os01” with the support target identifier “os01” within the storage unit 12a. In the example of FIG. 1, it is determined as a result of the comparison that the obtained identifier “os01” and the support target identifier “os01” within the storage unit 12a coincide with each other. In addition, the processing unit 12b determines whether or not information (error message) indicating a problem is included within the log 2c. In the example of FIG. 1, no error message is included. In this case, because no information indicating a problem is included within the log 2c, the processing unit 12b determines that an event as a support target has not occurred, and outputs the determination result. The person in charge of support informs the user that support is not to be provided based on the determination result.

Thus, even when the user makes a false communication, the person in charge of support does not need to provide support for the problem in the software excluded from the scope of application of the support contract.

Furthermore, the first information processing device 11 generates the identifiers of the respective OSes 2 and 3, and sets the identifiers in the OSes 2 and 3. Thus, even when the individual identifiers are not set in the OSes 2 and 3 in advance, the OSes 2 and 3 may be distinguished. Further, the identifiers of the respective OSes 2 and 3 are written to the registries 2a and 3a. Therefore, even when the OSes 2 and 3 together with the virtual machines are moved to another device by migration, individual identification of each OS may be performed based on the identifiers written to the registries.

Further, encrypting the logs and the identifiers included in the files 4 and 5 may suppress tampering with the contents of the files 4 and 5.

### Second Embodiment

A second embodiment will next be described. The second embodiment performs reliable OS individual identification, and thereby appropriately manages a support contract for software installed on an OS by using an identifier given to the OS.

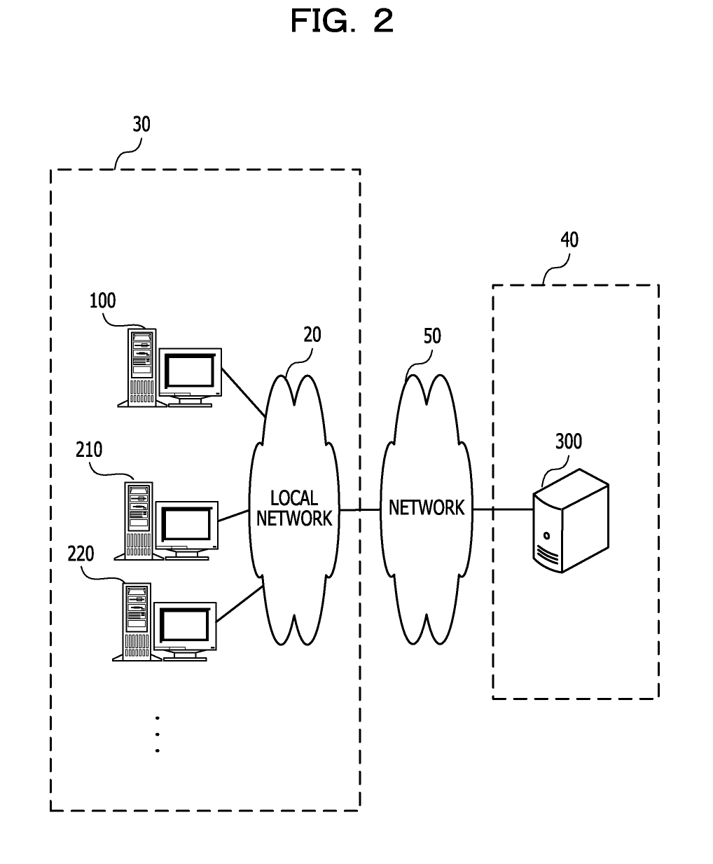

FIG. 2 is a diagram illustrating an example of a system configuration of the second embodiment. A customer company 30 is provided with various kinds of services related to a computer system from a service provider 40. The customer company 30, for example, possesses a plurality of servers 210, 220, . . . and a managing server 100. The servers 210, 220, . . . are computers used to carry out business in the customer company 30. The managing server 100 is a computer that assists in managing a contract for support service for software installed on the servers 210, 220, . . . .

The servers 210, 220, . . . and the managing server 100 are coupled to each other by a local network 20. In addition, the customer company 30 purchases the software to be installed on each of the servers 210, 220, . . . from the service provider 40, for example. The customer company 30 then receives the support service for the purchased software from the service provider 40. A user of the customer company 30, for example, generates an encrypted file for confirming a target of application of the support contract by using the managing server 100 coupled to the local network 20. The user of the customer company 30 sends the generated encrypted file to the service provider 40, and requests the support service.

The service provider 40 includes a support contract managing server 300. The support contract managing server 300 is a computer that manages a support license for the software sold to the customer company 30. The support contract managing server 300 is, for example, coupled to the local network 20 of the customer company 30 via a wide area network 50. The support contract managing server 300 may receive the encrypted file generated by the managing server 100 via the network 50, for example. Then, the support contract managing server 300 confirms whether there is a support contract for the software as a support target based on the encrypted file provided from the customer company 30. When it may be confirmed that there is a support contract, a person in charge of service of the service provider 40 performs software support service for the customer company 30.

Incidentally, the servers 210, 220, . . . illustrated in FIG. 2 are an example of the management target computer 1 illustrated in the first embodiment. In addition, the managing server 100 illustrated in FIG. 2 is an example of the first information processing device 11 illustrated in the first embodiment. The support contract managing server 300 illustrated in FIG. 2 is an example of the second information processing device 12 illustrated in the first embodiment.

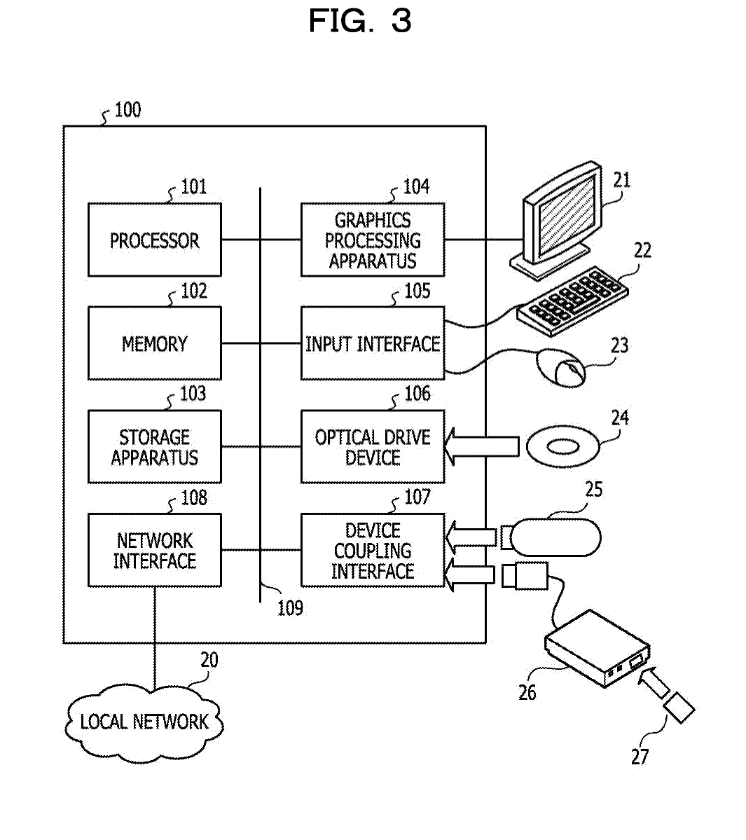

FIG. 3 is a diagram illustrating an example of hardware of a computer used in the second embodiment. The whole apparatus of the managing server 100 is controlled by a processor 101. The processor 101 is coupled with a memory 102 and a plurality of peripheral devices via a bus 109. The processor 101 may be a multiprocessor. The processor 101 is, for example, a central processing unit (CPU), a micro processing unit (MPU), or a digital signal processor (DSP). At least some of functions that the processor 101 implements by executing a program may be implemented by an electronic circuit such as an application specific integrated circuit (ASIC), a programmable logic device (PLD), or the like.

The memory 102 is used as a main storage device of the managing server 100. The memory 102 temporarily stores at least some of an OS program and an application program executed by the processor 101. In addition, the memory 102 stores various kinds of data needed for processing by the processor 101. A volatile semiconductor storage device such as a random access memory (RAM) is used as the memory 102.

The peripheral devices coupled to the bus 109 include a storage device 103, a graphics processing device 104, an input interface 105, an optical drive device 106, a device coupling interface 107, and a network interface 108.

The storage device 103 electrically or magnetically writes and reads data to and from an internal recording medium. The storage device 103 is used as an auxiliary storage device of the computer. The storage device 103 stores the OS program, an application program, and various kinds of data. Incidentally, a hard disk drive (HDD) and a solid state drive (SSD), for example, may be used as the storage device 103.

The graphics processing device 104 is coupled with a monitor 21. The graphics processing device 104 displays an image on a screen of the monitor 21 according to an instruction from the processor 101. As the monitor 21, there are a display device using a cathode ray tube (CRT), a liquid crystal display device, and the like.

The input interface 105 is coupled with a keyboard 22 and a mouse 23. The input interface 105 transmits signals sent from the keyboard 22 and the mouse 23 to the processor 101. Incidentally, the mouse 23 is an example of a pointing device, and other pointing devices may also be used. The other pointing devices include a touch panel, a tablet, a touch pad, a trackball, and the like.

The optical drive device 106 reads data recorded on an optical disk 24 using laser light or the like. The optical disk 24 is a portable recording medium on which data is recorded so as to be readable by the reflection of light. As the optical disk 24, there are a digital versatile disc (DVD), a DVD-RAM, a compact disc read only memory (CD-ROM), a CD-recordable (R)/rewritable (RW), and the like.

The device coupling interface 107 is a communication interface for coupling peripheral devices to the managing server 100. For example, the device coupling interface 107 may be coupled with a memory device 25 and a memory reader-writer 26. The memory device 25 is a recording medium having a function of communicating with the device coupling interface 107. The memory reader-writer 26 is a device that writes data to a memory card 27 or reads data from the memory card 27. The memory card 27 is a card type recording medium.

The network interface 108 is coupled to the local network 20. The network interface 108 transmits and receives data to and from another computer or a communicating device via the local network 20.

Processing functions of the second embodiment may be implemented by the hardware configuration as described above. Incidentally, the servers 210, 220, . . . and the support contract managing server 300 may also be implemented by hardware similar to that of the managing server 100 illustrated in FIG. 3. In addition, the first information processing device 11 and the second information processing device 12 illustrated in the first embodiment may also be implemented by hardware similar to that of the managing server 100 illustrated in FIG. 3.

The managing server 100 implements the processing functions of the second embodiment by executing a program recorded on a computer readable recording medium, for example. A program describing processing contents to be executed by the managing server 100 may be recorded on various recording media. For example, a program to be executed by the managing server 100 may be stored in the storage device 103. The processor 101 loads at least part of the program within the storage device 103 into the memory 102, and executes the program. In addition, the program to be executed by the managing server 100 may also be recorded on a portable recording medium such as the optical disk 24, the memory device 25, the memory card 27, or the like. The program stored on the portable recording medium becomes executable after being installed on the storage device 103 under control of the processor 101, for example. The processor 101 may also directly read and execute the program from the portable recording medium.

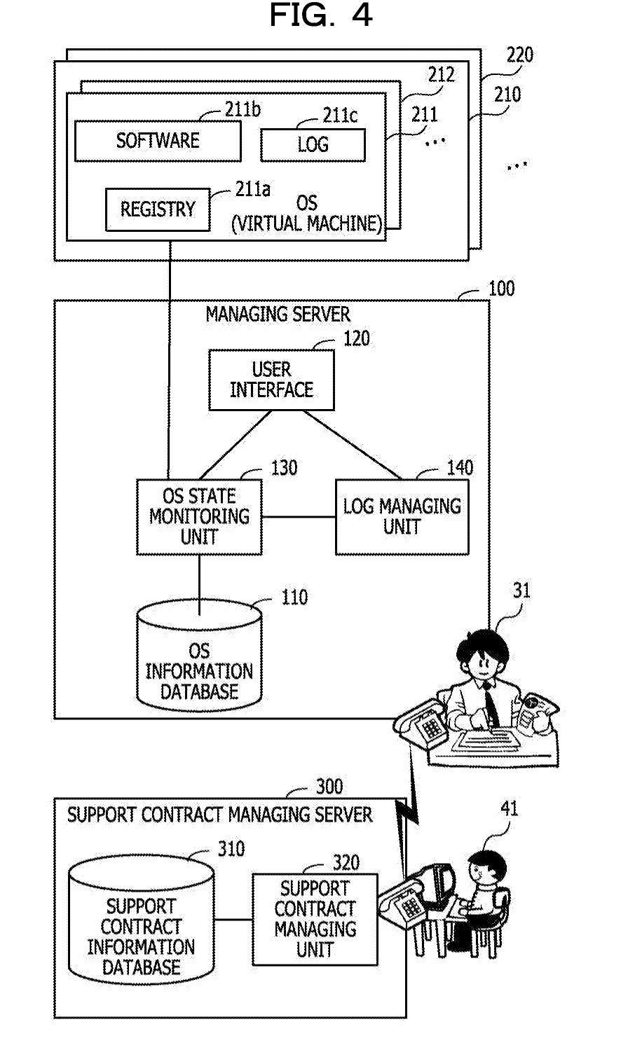

FIG. 4 is a block diagram illustrating an example of functions of respective devices in the second embodiment. The servers 210, 220, . . . are each executing one or more OSes. For example, the server 210 is executing a plurality of OSes 211, 212, . . . . The execution of the plurality of OSes 211, 212, . . . may be implemented by using a hypervisor, for example. For example, the server 210 constructs a plurality of virtual machines (VMs) within the server 210 by using the hypervisor. The server 210 then executes OSes 211, 212, . . . in the constructed plurality of virtual machines individually.

The OS 211 executed by the server 210 includes a registry 211a. The registry 211a is a database for storing setting information in the OS 211. In addition, software 211b as a management target of a software support contract may be installed on the OS 211. When the OS 211 executes the software 211b, a log 211c accumulating messages indicating various events occurring in a process of the execution of the software 211b is generated. The log 211c, for example, includes an error message indicating an error occurring during the execution of the software 211b. The error message includes an error code indicating a type of error, for example.

Incidentally, without limitation to the OS 211, as with the OS 211, an OS executed by one of the servers 210, 220, . . . includes a registry, and has a log corresponding to software when the software is executed.

The managing server 100 includes an OS information database 110, a user interface 120, an OS state monitoring unit 130, and a log managing unit 140.

The OS information database 110 is a database storing information related to OSes operating on the servers 210, 220, . . . . Part of a storage area of the memory 102 or the storage device 103 of the managing server 100, for example, is used as the OS information database 110.

The user interface 120 receives an input from a user 31 within the customer company 30, and displays a processing result corresponding to the input.

The OS state monitoring unit 130 monitors the states of the OSes operating on the servers 210, 220, . . . . The OS state monitoring unit 130, for example, gives an OS management number and an OS management key to each OS. The OS management number is an identifier of the OS. The OS management key is, for example, a sequence of characters, numbers, or symbols generated randomly. The OS state monitoring unit 130, for example, remotely logs in to the OS 211, and stores the OS management number and the OS management key of the OS 211 in the registry 211a of the OS 211. The OS state monitoring unit 130 then manages the state of the OS using the OS management number and the OS management key.

The log managing unit 140 manages the logs output by the software in the servers 210, 220, . . . . The log managing unit 140, for example, obtains the log of one of the servers via the OS state monitoring unit 130, and encrypts the log. The log managing unit 140, for example, performs the encryption using a public key provided from the service provider 40. The encrypted log is sent by the user 31 to the person 41 in charge of support in the service provider 40 as a record of trouble contents at a time of a support request.

The support contract managing server 300 includes a support contract information database 310 and a support contract managing unit 320.

The support contract information database 310 stores information related to a support contract concluded between the customer company 30 and the service provider 40. Part of a storage area of a memory or a storage device possessed by the support contract managing server 300, for example, is used as the support contract information database 310.

The support contract managing unit 320 receives an input to the support contract information database 310 from the person 41 in charge of support within the service provider 40, and displays a result of processing on the support contract information database 310 in response to the input. The support contract managing unit 320 also decrypts an encrypted file. The support contract managing unit 320, for example, decrypts, by a private key of the service provider 40, encrypted data obtained by encrypting the log of software causing a problem, the OS management number of an OS on which the software is installed, and the like. Further, the support contract managing unit 320 refers to information such as the log and the like obtained by the decryption, and performs confirmation processing of confirming whether or not the support target software in the support request from the user 31 is a target of the support contract.

Information managed by each device will next be described concretely.

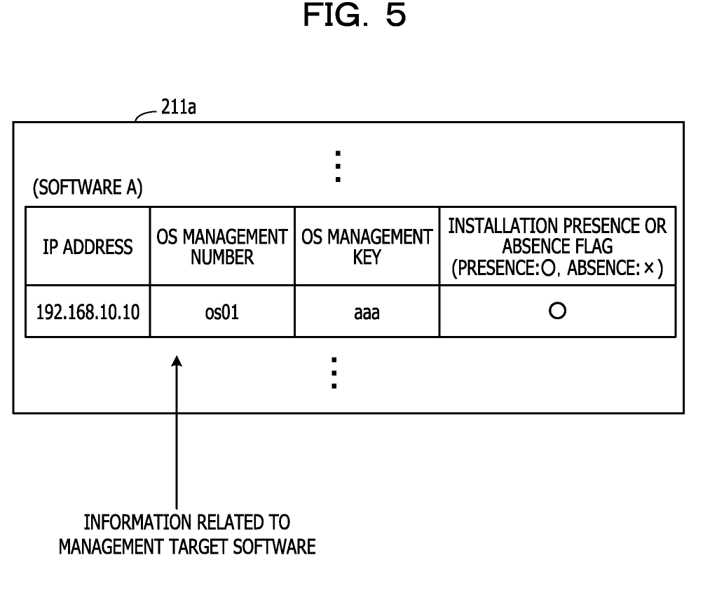

FIG. 5 is a diagram illustrating an example of a registry. Set in the registry 211a of the OS 211 is information related to a configuration of the OS 211 and a configuration of the software installed on the OS 211. The information set in the registry 211a includes an IP address, an OS management number, an OS management key, and an installation presence or absence flag as information related to the software 211b. These pieces of information are registered in the registry 211a in association with a product name “software A” of the software 211b, for example.

The IP address within the information related to the software 211b is an IP address of the OS 211. The OS management number within the information related to the software 211b is an identification number for uniquely identifying the OS within the customer company 30. The OS management key within the information related to the software 211b is data used to, when a copy of the OS is generated, distinguish the plurality of OSes generated as a result of the copying. The installation presence or absence flag within the information related to the software 211b is a flag indicating whether or not the software 211b is installed on the OS 211. Suppose in the example of FIG. 5 that a circle mark is set to the installation presence or absence flag when the software 211b is installed, and that a cross mark is set to the installation presence or absence flag when the software 211b is not installed. Incidentally, as data, for example, a value of “1” is substituted for the circle mark and is stored, and a value of “0” is substituted for the cross mark and is stored.

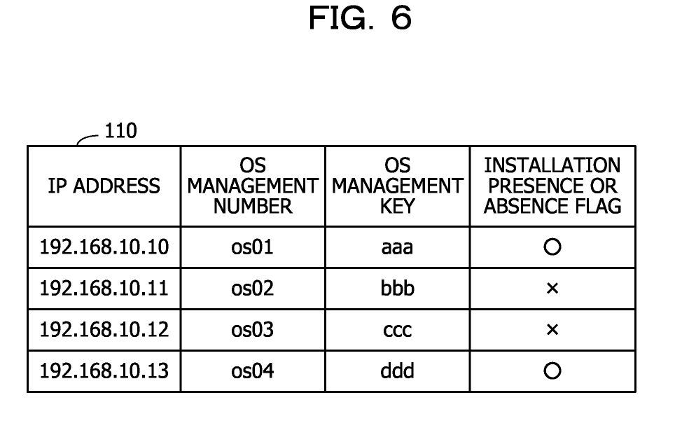

FIG. 6 is a diagram illustrating an example of an OS information database. In the OS information database 110, a record for each of the OSes executed within the servers 210, 220, . . . stores information related to software on the corresponding OS. Each record within the OS information database 110, for example, includes an IP address, an OS management number, an OS management key, and an installation presence or absence flag.

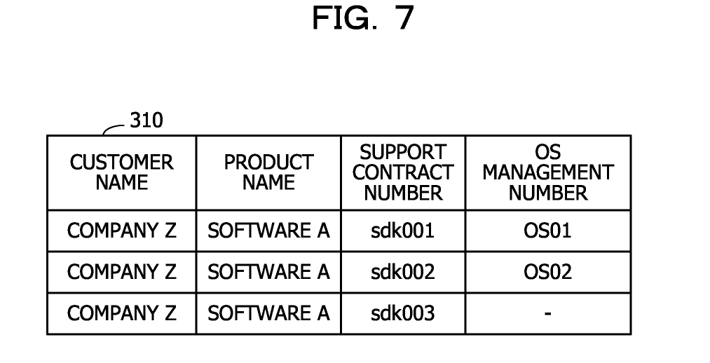

FIG. 7 is a diagram illustrating an example of a support contract information database. In the support contract information database 310, a record for each support contract for one piece of software with a customer company stores information related to the support contract. Each record within the support contract information database 310, for example, includes a customer name, a product name, a support contract number, and an OS management number. The customer name is a name of a customer that has concluded the support contract. The product name is a product name of the software as a support target. The support contract number is an identification number for identifying the support contract for one piece of software. The OS management number is an identification number of an OS on which the software as a support target is installed. Incidentally, as for a record related to a support contract in which support target software is not determined, the OS management number is not set yet (blank).

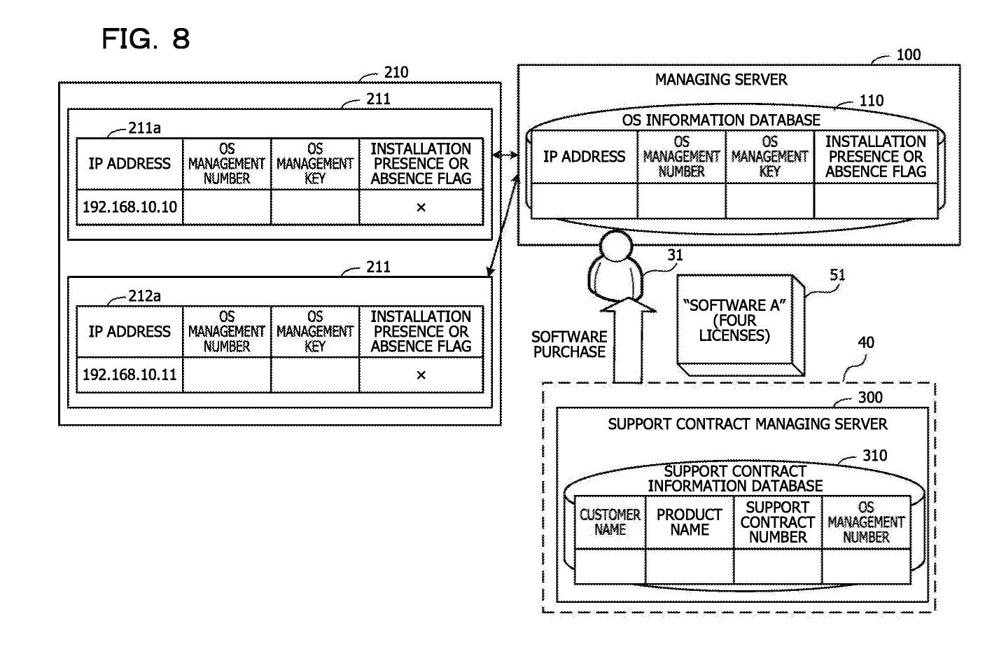

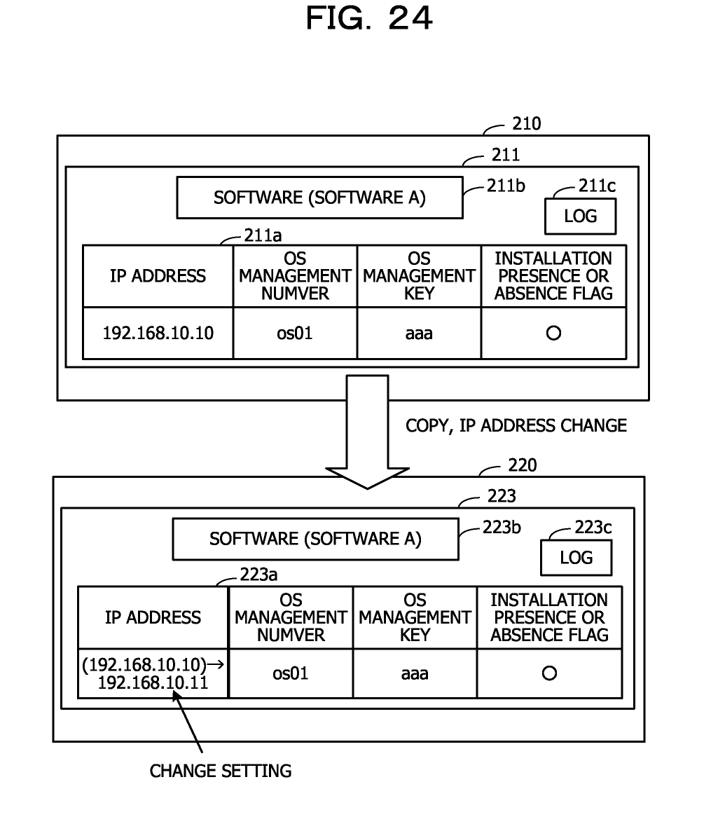

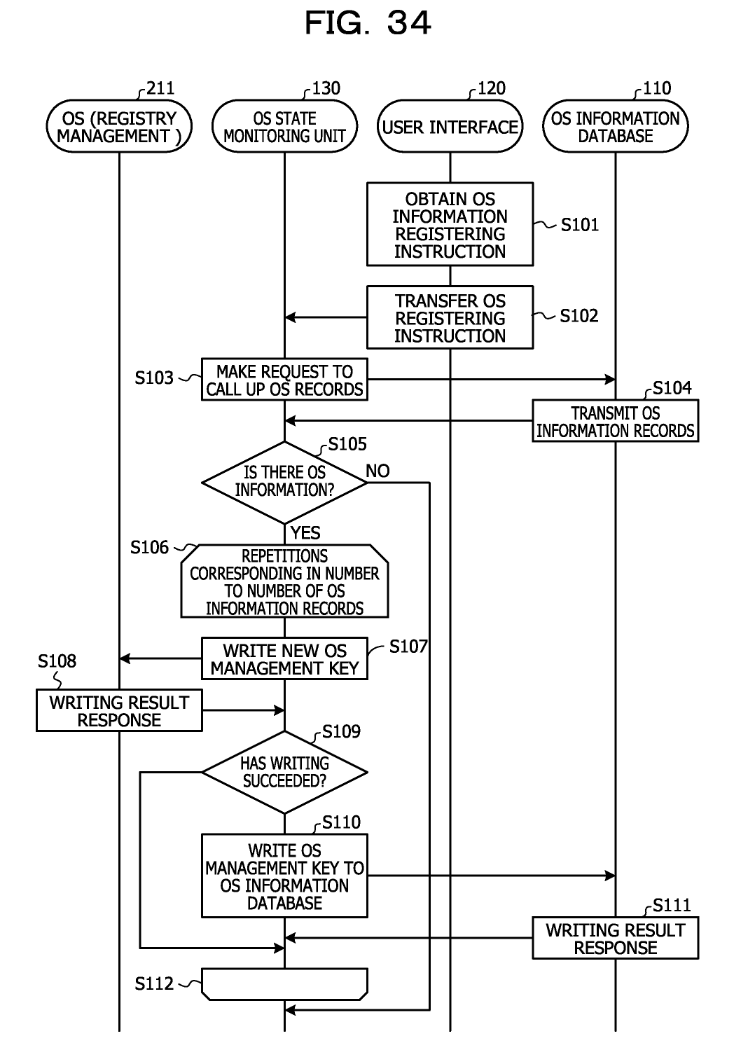

Support contracts for software are managed by using data as described above. In the following description, referring to FIGS. 8 to 23, description will first be made of a basic procedure from conclusion of a support contract for software between the customer company 30 and the service provider 40 to provision of support service to the customer company 30. Thereafter, referring to FIGS. 24 to 33, description will be made of a dealing procedure in a case where a virtual machine together with an OS is copied. Finally, referring to FIGS. 34 to 40, description will be made of an overall processing procedure of support contract management processing assuming a case where a virtual machine together with an OS is copied.

### <Procedure of Providing Support Service>

Description will first be made of a procedure of providing the customer company 30 with support for software within the scope of a support contract without assuming a case where a virtual machine together with an OS is copied.

FIG. 8 is a diagram illustrating an example of a state before software installation. The user 31, for example, purchases a software package 51 from the service provider 40. The software package 51 indicates the number of OSes on which the installation may be performed by the number of licenses. In the example of FIG. 8, the number of licenses of the software package 51 is “4.” For example, the customer company 30 has a right to install software on four OSes using the software package 51.

The software package 51 is, for example, a computer readable recording medium. The user 31 may also receive only electronic data as the software package 51 via the network 50. In this stage, software as a management target is not installed on any of the servers. Therefore, an installation presence or absence flag indicating no installation is set in the registries 211a and 212a of the respective OSs 211 and 212 within the server 210, for example.

The user 31 of the customer company 30, the user 31 having purchased the software package 51, installs the software on one of the OSes within the servers 210, 220, . . . by using the software package 51, and makes the server perform information processing using the software. In addition, the customer company 30 may be provided with support service for the software from the service provider 40 by concluding a support contract for the software with the service provider 40.

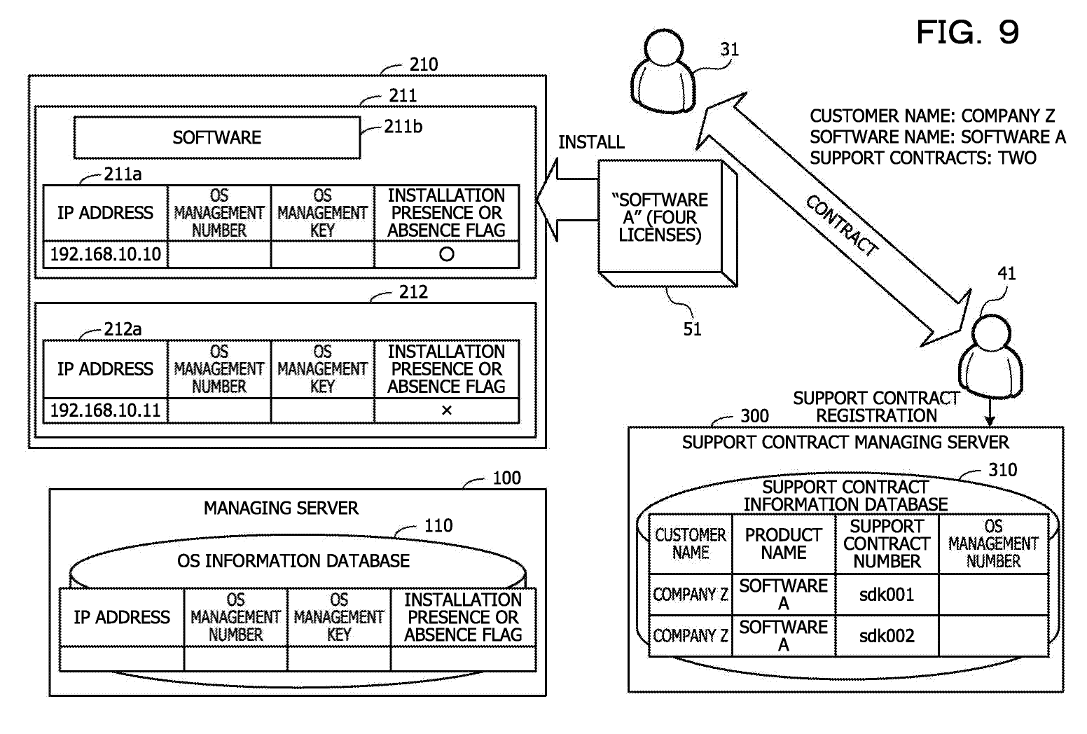

FIG. 9 is a diagram illustrating an example of a state after software installation and conclusion of a support contract. At a time of the software purchase, the user 31 of the customer company 30, for example, notifies a customer name (company Z), a software name (software A), and the number of support contracts (two) to the person 41 in charge of support of the service provider 40. When the support contracts are established between the customer company 30 and the service provider 40, the person 41 in charge of support stores information related to the concluded support contracts in the support contract information database 310 within the support contract managing server 300.

In the example of FIG. 9, the customer company 30 purchases two support contracts, and therefore two records are added to the support contract information database 310. A common customer name and a common product name are set in the two added records. In addition, support contract numbers of the two added records are different values.

After the conclusion of the support contracts, the user 31 installs the software by using the software package 51. In the example of FIG. 9, the software 211b is installed on the OS 211. When the user 31 installs the software 211b on the OS 211, installation information of the software 211b is written to the registry 211a of the OS 211. For example, a value indicating the presence of an installation is set to the installation presence or absence flag.

In addition, the user 31 registers information related to the OS 211 on which the software 211b is installed in the managing server 100 as a preparation for receiving support based on the support contract.

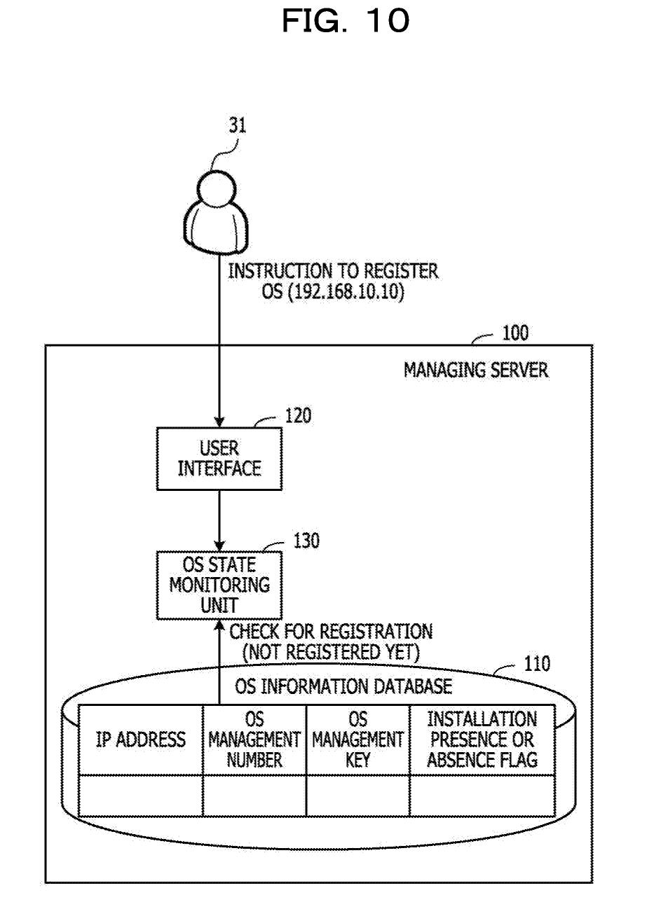

FIG. 10 is a first diagram illustrating an example of conditions of registration of OS information into a managing server. The user 31 performs an input instructing the user interface 120 to register the OS 211 on which the support target software is installed into the OS information database 110. The user 31, for example, inputs a registering instruction including the IP address of the OS 211. The registering instruction is received by the user interface 120, and transferred to the OS state monitoring unit 130.

Receiving the registering instruction, the OS state monitoring unit 130 first obtains a record indicating already registered OS information from the OS information database 110. At this time, when a record is registered in the OS information database 110, the OS state monitoring unit 130 performs processing of rewriting the OS management key of the obtained record. However, in the example of FIG. 10, no OS information record is registered, and therefore the processing of rewriting the OS management key is not performed.

After confirming that there is no record indicating OS information in the OS information database 110, the OS state monitoring unit 130 performs processing of registering OS information according to the registering instruction.

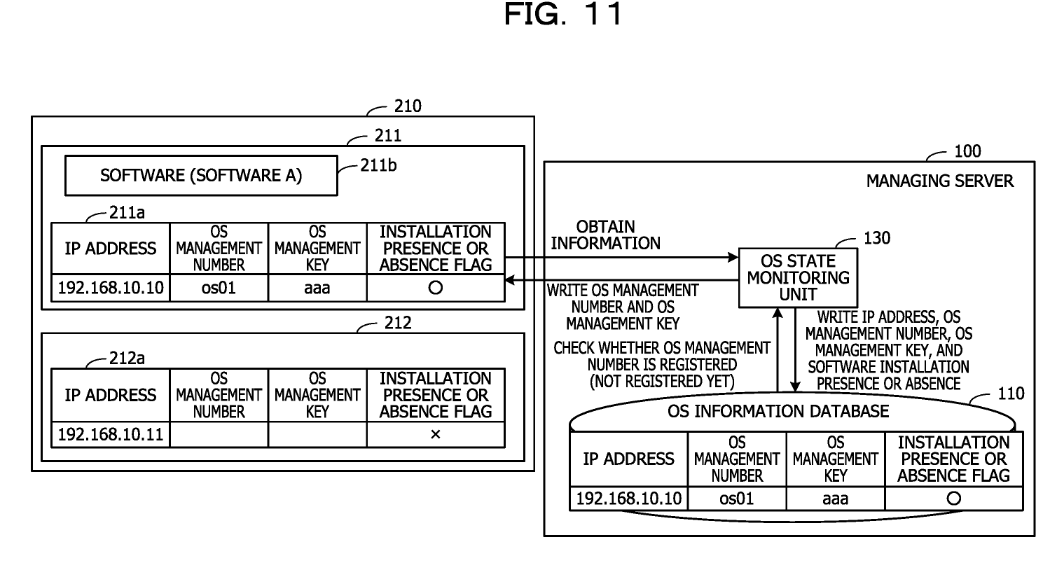

FIG. 11 is a second diagram illustrating an example of conditions of registration of OS information into a managing server. The OS state monitoring unit 130 first obtains pieces of information including an OS management number, an OS management key, and an installation presence or absence flag from the registry 211a of the OS 211 as a management target. In this stage, the OS management number and the OS management key are not registered in the registry 211a. Hence, the OS state monitoring unit 130 may obtain only the installation presence or absence flag.

Next, the OS state monitoring unit 130 refers to the OS information database 110, and checks whether the obtained OS management number is already registered or not. In the example of FIG. 11, the OS management number is not registered yet in the checking stage.

In the case where the OS management number is not registered in the OS information database 110, the OS state monitoring unit 130 generates a new OS management number and a new OS management key, and writes the new OS management number and the new OS management key to the registry 211a of the OS 211. Further, the OS state monitoring unit 130 registers, in the OS information database 110, a new record including the information related to the software 211b, the information being registered in the registry 211a of the OS 211. In the example of FIG. 11, a record in which an IP address “192.168.10.10” of the OS 211, an OS management number “os01,” an OS management key “aaa,” and an installation presence or absence flag “o” are set is registered in the OS information database 110.

The OS management number and the OS management key are thus given to the OS 211 on which the software 211b is installed. Then, the same contents as the information stored in the registry 211a of the OS 211 and related to the software 211b are registered in the OS information database 110 within the managing server 100.

The example of FIG. 11 represents processing in the case where the user 31 inputs an instruction to register the OS 211 on which the software 211b is already installed. However, the user 31 may also input a registering instruction related to an OS on which software is not installed yet.

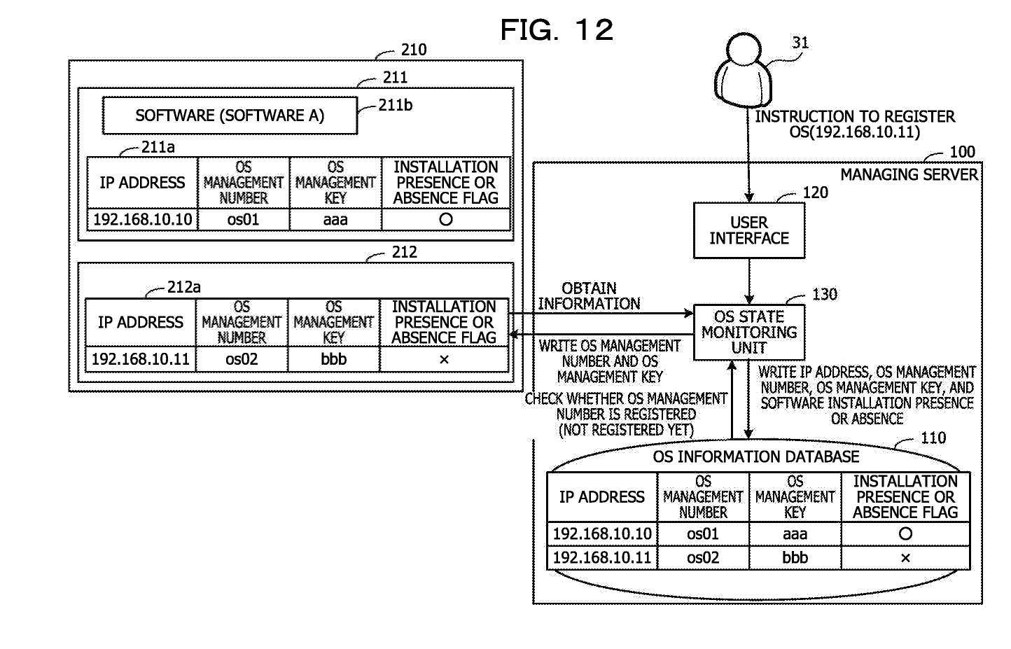

FIG. 12 is a third diagram illustrating an example of conditions of registration of OS information into a managing server. In the example of FIG. 12, the user 31 inputs, to the managing server 100, a registering instruction related to the OS 212 on which no software is installed. The input registering instruction is received by the user interface 120, and transferred to the OS state monitoring unit 130. At this time, as illustrated in FIG. 10, the OS state monitoring unit 130 checks whether a record is registered in the OS information database 110 and updates the OS management key of the registered record. However, in FIG. 12, those pieces of processing are omitted.

The OS state monitoring unit 130 first obtains pieces of information including an OS management number, an OS management key, and an installation presence or absence flag from the registry 212a of the OS 212 as a management target. Next, the OS state monitoring unit 130 refers to the OS information database 110, and checks whether the obtained OS management number is already registered or not. In the example of FIG. 12, the obtained OS management number is not registered yet in the checking stage. Accordingly, the OS state monitoring unit 130 generates a new OS management number and a new OS management key, and writes the new OS management number and the new OS management key to the registry 212a of the OS 212. Further, the OS state monitoring unit 130 registers, in the OS information database 110, a new record including information related to software, the information being registered in the registry 212a of the OS 212. In the example of FIG. 12, a record in which an IP address “192.168.10.11” of the OS 212, an OS management number “os02,” an OS management key “bbb,” and an installation presence or absence flag “x” are set is registered in the OS information database 110.

Thus, also for the OS 212 on which software is not installed yet, a corresponding record may be registered in the OS information database 110 of the managing server 100. Then, after the instruction for the registration into the managing server 100, the user 31 may install software on the OS 212.

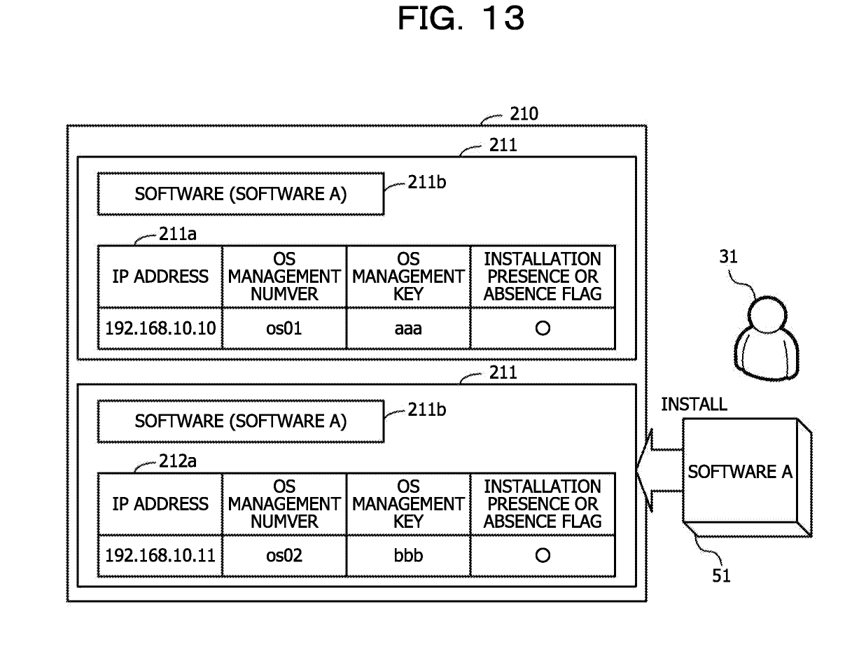

FIG. 13 is a diagram illustrating an example of conditions of installation of software after registration into a managing server. The user 31, for example, installs software 212b on the OS 212 by using the software package 51. When the user 31 installs the software 212b on the OS 212, installation information of the software 212b is written to the registry 212a of the OS 212. For example, a value indicating the presence of an installation is set to the installation presence or absence flag.

Immediately after the software 212b is installed on the OS 212, the information related to the software 212b, the information being indicated in the registry 212a, is not reflected in the OS information database 110 of the managing server 100. Accordingly, the managing server 100 periodically obtains the installation presence or absence flag of the software.

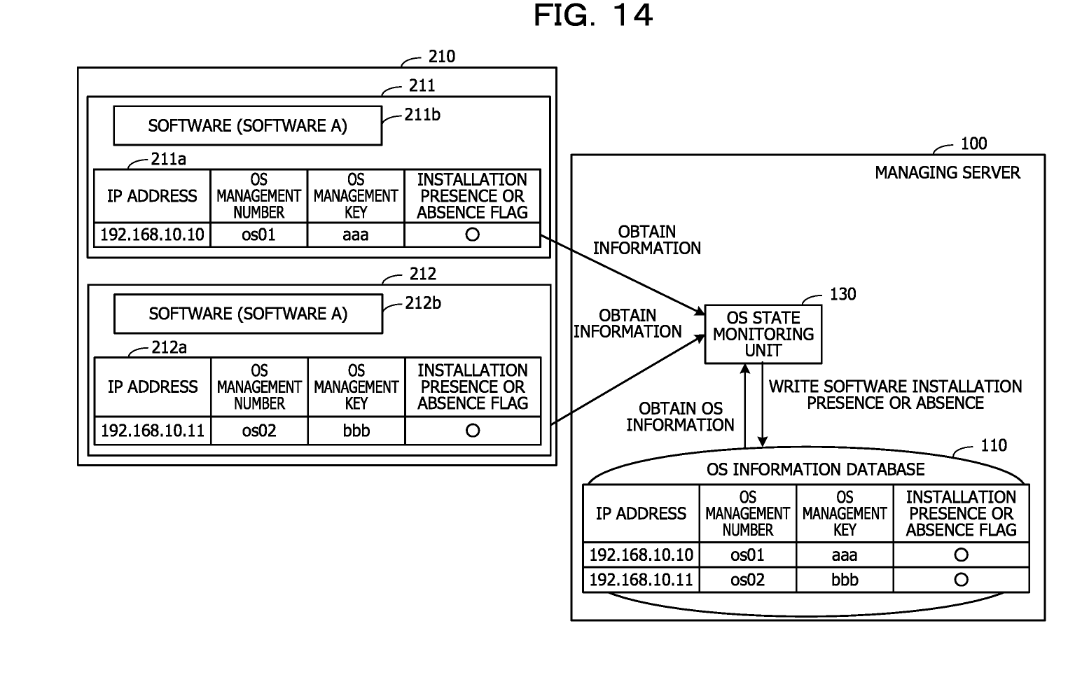

FIG. 14 is a diagram illustrating an example of conditions of periodic obtainment of an installation presence or absence flag. The OS state monitoring unit 130 of the managing server 100 performs processing of obtaining the installation presence or absence flag at intervals of a set time. The OS state monitoring unit 130, for example, obtains the records of the registered OSes 211 and 212 from the OS information database 110. The OS state monitoring unit 130 next obtains installation presence or absence flags from the registries 211a and 212a of the respective OSes 211 and 212 whose records are already registered. The OS state monitoring unit 130 then writes the installation presence or absence flags obtained from the respective OSes 211 and 212 to the OS information database 110.

Thus, even in a case where software is installed on an OS after information related to the OS is registered in the managing server 100, the managing server 100 may grasp that the software is installed.

Suppose that the software is thereafter installed also on two OSes within the server 220, and that records indicating information of those OSes are stored in the OS information database 110. Thus, the software is installed on the OSes corresponding in number to the number of licenses of the software package 51.

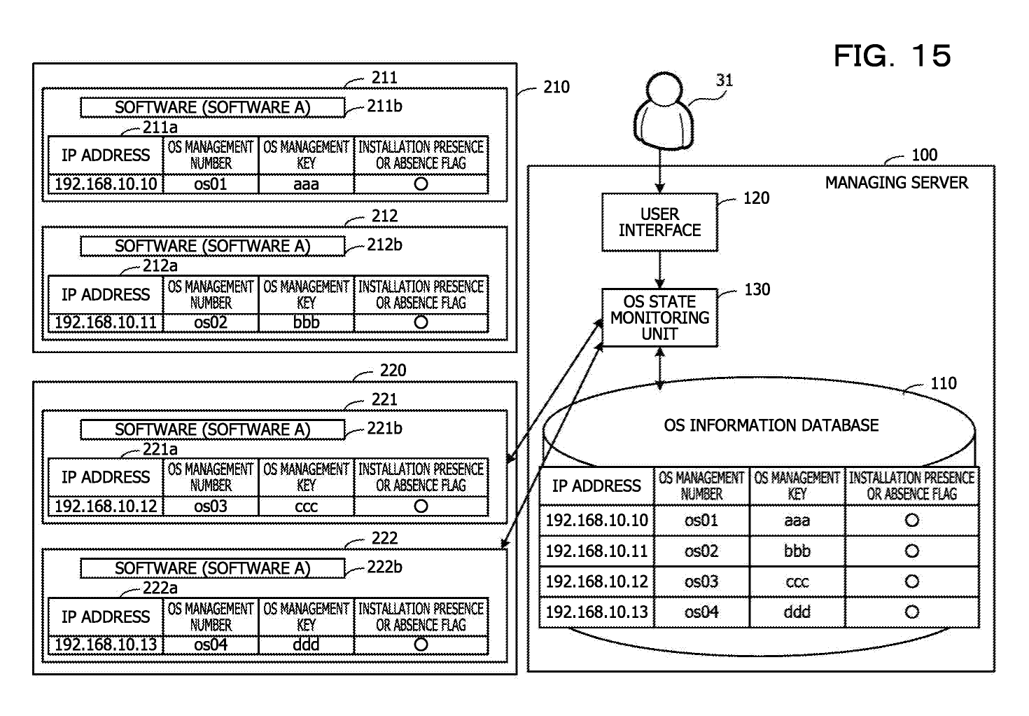

FIG. 15 is a diagram illustrating an example of a state after software installations corresponding in number to the number of licenses. Two OSes 221 and 222 are executed on the server 220. Pieces of software 221b and 222b are installed on the respective OSes 221 and 222. Information related to the installed software 221b and 222b is registered in registries 221a and 222a of the respective OSes 221 and 222.

Records corresponding to the two OSes 221 and 222 individually, within the server 220 are registered in the OS information database 110 of the managing server 100. Set in each record are an IP address of the corresponding OS, an OS management number, an OS management key, and an installation presence or absence flag indicating that the software is already installed.

The OSes executed on the respective servers 210 and 220 may change the IP addresses of the OSes. An OS whose IP address is changed does not have the OS management number of the OS changed, but has the OS management key of the OS changed.

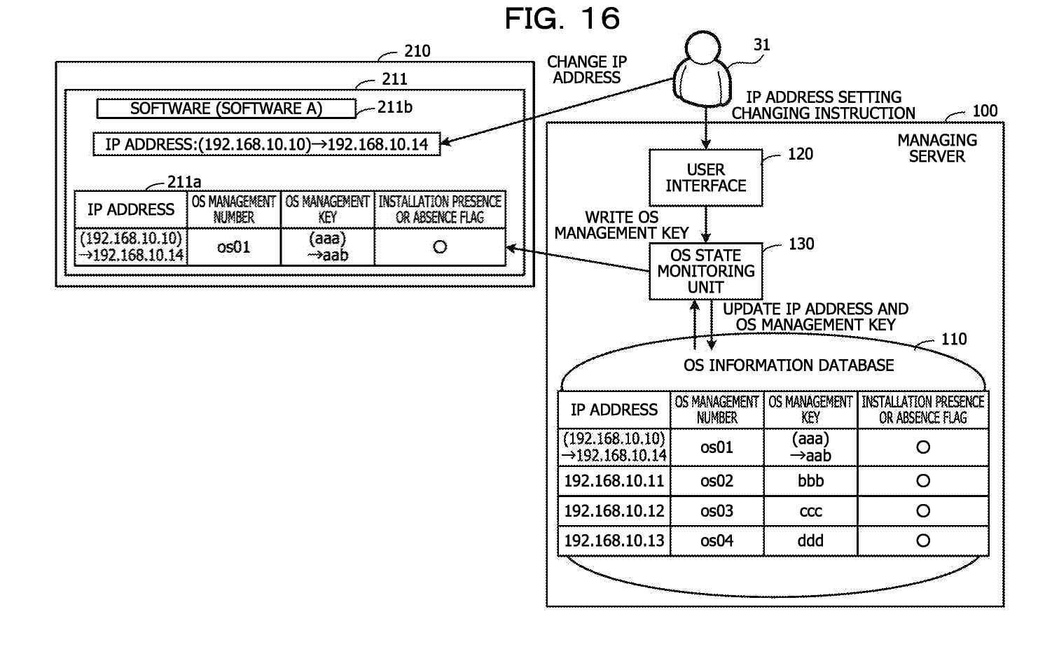

FIG. 16 is a diagram illustrating an example of conditions of changing an IP address. In the example of FIG. 16, the user 31 changes the IP address of the OS 211 within the server 210 from “192.168.10.10” to “192.168.10.14.” After the user 31 changes the IP address of the OS 211, the user 31 instructs the managing server 100 to change the IP address of the OS 211. For example, the user 31 inputs, to the managing server 100, an IP address setting change instruction specifying the IP address “192.168.10.10” before the change and the IP address “192.168.10.14” after the change.

In the managing server 100, the user interface 120 receives the IP address setting change instruction. The user interface 120 transfers the obtained IP address setting change instruction to the OS state monitoring unit 130. The OS state monitoring unit 130 obtains a record corresponding to the IP address “192.168.10.10” before the change from the OS information database 110. Next, the OS state monitoring unit 130 generates a new OS management key “aab” for the OS 211. Further, the OS state monitoring unit 130 accesses the OS 211 based on the IP address after the change, and writes the newly generated OS management key “aab” as an OS management key in the registry 211a within the OS 211.

In addition, the OS state monitoring unit 130 updates the IP address of the obtained record to the IP address “192.168.10.14” after the change, and updates the OS management key of the record to the newly generated OS management key “aab.” The OS state monitoring unit 130 then writes back the updated record to an original position within the OS information database 110.

Thus, when the IP address of an OS is changed, the IP address and the OS management key of a record corresponding to the OS within the OS information database 110 are updated.

The user 31 carries out business using the software installed on the OSes. When the software is used, some problem may occur. The problem may be caused by the software itself, may be caused by an OS, or may be caused by a server executing the OS, for example, and it may be difficult for the user 31 to determine the cause of the problem by himself/herself. In such a case, the user 31 may receive support for the software from the service provider 40 based on a support contract.

Description will next be made of a support request procedure in a case where a problem occurs during the use of one of the installed pieces of software.

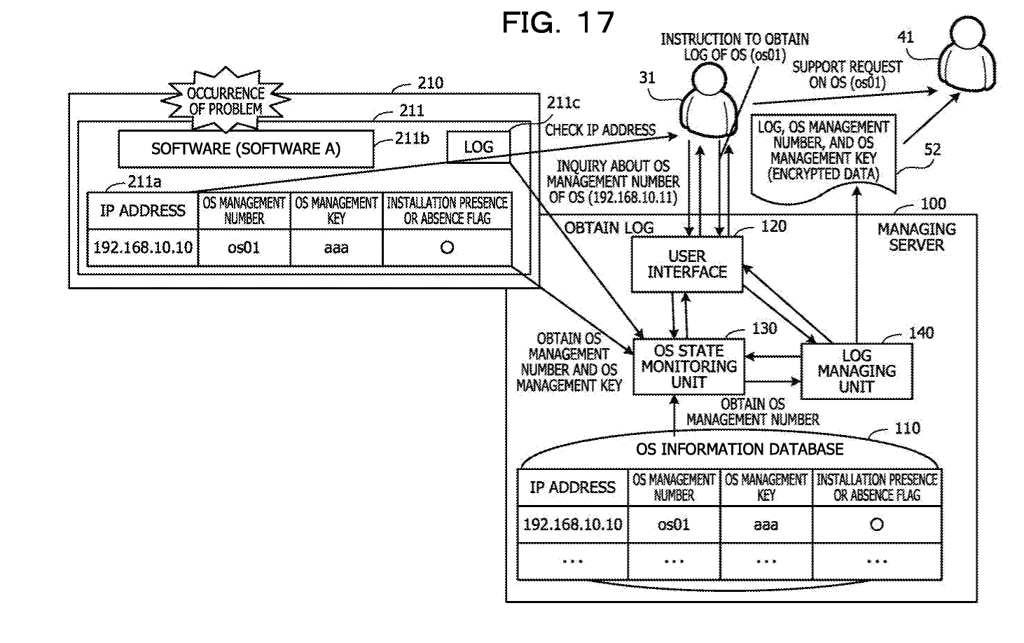

FIG. 17 is a first diagram illustrating an example of a support request. In the example of FIG. 17, a problem of the software 211b occurs on the OS 211 within the server 210. When the problem occurs in the software 211b, a message (for example, error message) corresponding to the problem is stored in the log 211c.

When the user 31 recognizes that a problem has occurred in the software 211b, the user 31 checks the IP address of the OS 211. In the example of FIG. 17, the IP address of the OS 211 is “192.168.10.10.”

The user 31 inputs an inquiry about the OS management number of the OS 211 to the managing server 100 with the IP address of the OS 211 as a key. The inquiry about the OS management number is received by the user interface 120. In response to the obtained inquiry about the OS management number, the user interface 120 transmits an OS management number obtaining request to the OS state monitoring unit 130. The OS state monitoring unit 130 obtains the OS management number “os01” from a record corresponding to the IP address of the OS 211 within the OS information database 110. The OS state monitoring unit 130 transmits the obtained OS management number to the user interface 120. The user interface 120 displays the received OS management number on the monitor 21.

The user 31 checks the OS management number displayed on the monitor 21, and inputs, to the managing server 100, a log obtaining instruction related to the software 211b on the OS 211 corresponding to the OS management number. The log obtaining instruction is received by the user interface 120. The user interface 120 transmits the obtained log obtaining instruction to the log managing unit 140.

The log managing unit 140 obtains the log 211c, the OS management number, and the OS management key of the OS 211 via the OS state monitoring unit 130. For example, the log managing unit 140 transmits a log obtaining request for the OS management number “os01” to the OS state monitoring unit 130. In response to the log obtaining request, the OS state monitoring unit 130 obtains the log 211c, the OS management number “os01,” and the OS management key “aaa” from the OS 211 corresponding to the OS management number “os01.” The OS state monitoring unit 130 transfers the information obtained from the OS 211 to the log managing unit 140.

The log managing unit 140 encrypts the obtained log, the obtained OS management number, and the obtained OS management key, and generates a file 52 including the data that is encrypted (encrypted data). Then, the log managing unit 140 outputs the generated file 52. For example, the log managing unit 140 stores the generated file 52 in a given folder (directory) within the storage device 103, and transmits a log obtainment completion response to the user interface 120. The user interface 120 displays information indicating that the storing of the file including the log is completed on the monitor 21.

The user 31 makes a support request to the person 41 in charge of support of the service provider 40. The support request is made by means such as telephone, electronic mail or the like. At a time of the support request, the user 31 notifies the customer name, the OS management number, and the software name to the person 41 in charge of support. In addition, the user 31 sends the encrypted file 52 to the person 41 in charge of support. For example, the user 31 attaches the file 52 to a support request electronic mail by using an electronic mail function of the managing server 100, and transmits the support request electronic mail to an email address of the person 41 in charge of support.

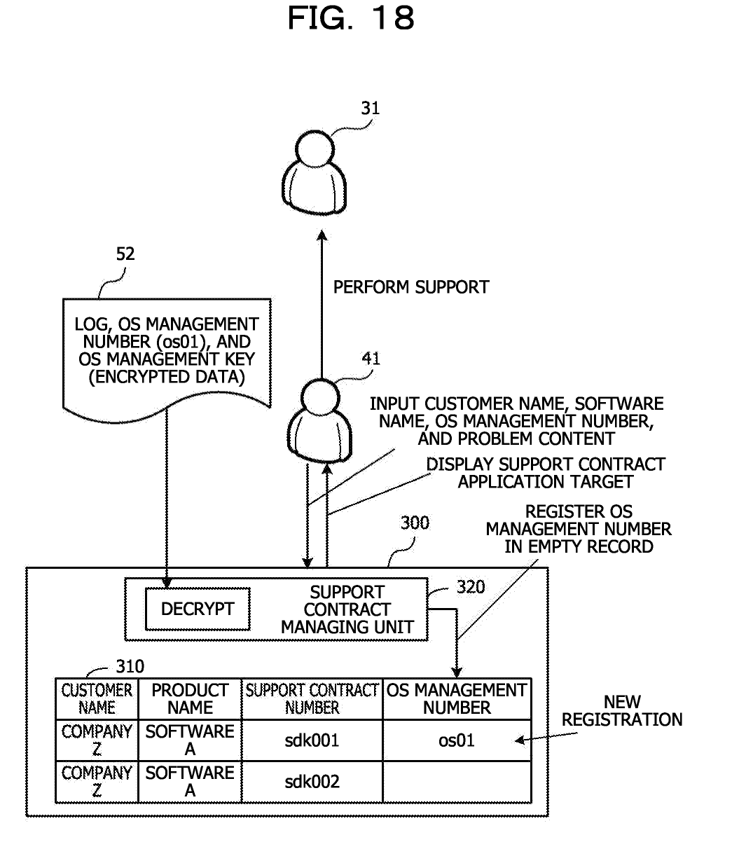

FIG. 18 is a second diagram illustrating an example of a support request. Receiving the support request, the person 41 in charge of support inputs the file 52 received from the user 31 to the support contract managing server 300. The input file 52 is decrypted by the support contract managing unit 320. The person 41 in charge of support, for example, stores the file 52 within the storage device of the support contract managing server 300. The person 41 in charge of support then inputs an instruction to decrypt the file 52 to the support contract managing server 300.

The decrypting instruction is received by the support contract managing unit 320. The support contract managing unit 320 decrypts the data within the file 52, and stores a new file including the decrypted data in the storage device.

In addition, the person 41 in charge of support inputs, to the support contract managing server 300, the customer name, the software name, the OS management number, and the content of the problem, which are notified from the user 31. Then, the support contract managing unit 320 refers to information within the decrypted file, and confirms the log of the OS having the OS management number notified from the user 31 and the occurrence of the problem of the content for which the support request is received.

Next, with the customer name and the software name as a key, the support contract managing unit 320 obtains records indicating the support contracts corresponding to a set of the customer name and the software name from the support contract information database 310. The support contract managing unit 320 then checks whether the obtained records of the support contracts include a record in which the value of the field of the OS management number coincides with the OS management number notified from the user 31. In the example of FIG. 18, there is no such record. Accordingly, the support contract managing unit 320 checks whether the extracted records of the support contracts include a record in which the field of the OS management number is blank. In the example of FIG. 18, there is a record in which the field of the OS management number is blank.

The support contract managing unit 320 registers the OS management number input this time in the field of the OS management number of the record in which the field of the OS management number is blank. In the example of FIG. 18, the OS management number “os01” is set to a first record in the support contract information database 310. One support contract and the OS management number are thereby associated with each other.

The support contract managing unit 320 then displays information indicating that the software having the problem is a target of application of the support contract. The person 41 in charge of support confirms that the software having the problem is a target of application of the support contract, and provides the user 31 with support for the software 211b.

As a result of the processing illustrated in FIG. 18, a registration is made in the support contract information database 310, the registration indicating that the software 211b installed on the OS 211 having the OS management number “os01” is a target of the support contract. When a problem thereafter occurs in the software 211b, support is performed by the person 41 in charge of support after the support contract is confirmed.

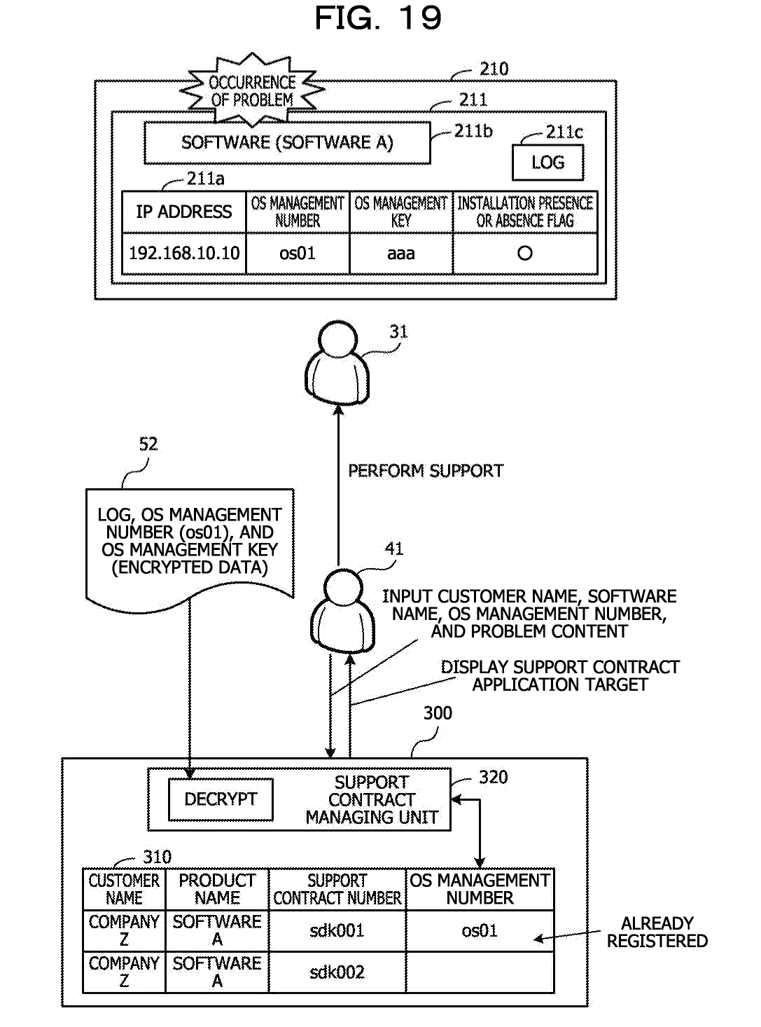

FIG. 19 is a diagram illustrating an example of dealing with a case where a problem occurs in software as a support contract target. When a problem occurs in the software 211b again, the user 31 makes a support request to the person 41 in charge of support, notifies the customer name, the OS management number, and the software name to the person 41 in charge of support, and sends an encrypted file 53 to the person 41 in charge of support.

The person 41 in charge of support inputs the customer name, the OS management number, and the software name to the support contract managing server 300, and makes the support contract managing unit 320 decrypt the file 53. The support contract managing unit 320 confirms the log of the OS having the OS management number notified from the user 31 and the occurrence of the problem of the content notified from the user 31 based on the decrypted data. In addition, with the customer name and the software name as a key, the support contract managing unit 320 obtains records of the support contracts corresponding to the key from the support contract information database 310. The support contract managing unit 320 then checks whether the obtained records of the support contracts include a record in which the field of the OS management number coincides with the OS management number notified from the user. In the example of FIG. 19, there is such a record. Accordingly, the support contract managing unit 320 displays information indicating that the software having the problem is a target of application of the support contract. The person 41 in charge of support confirms that the software having the problem is a target of application of the support contract, and provides the user 31 with support for the software 211b.

Thus, when a problem occurs in the software 211b that is already a target of the support contract, support is performed based on the support contract.

Description will next be made of a case where a problem occurs in different software from the software 211b as a target of the support contract.

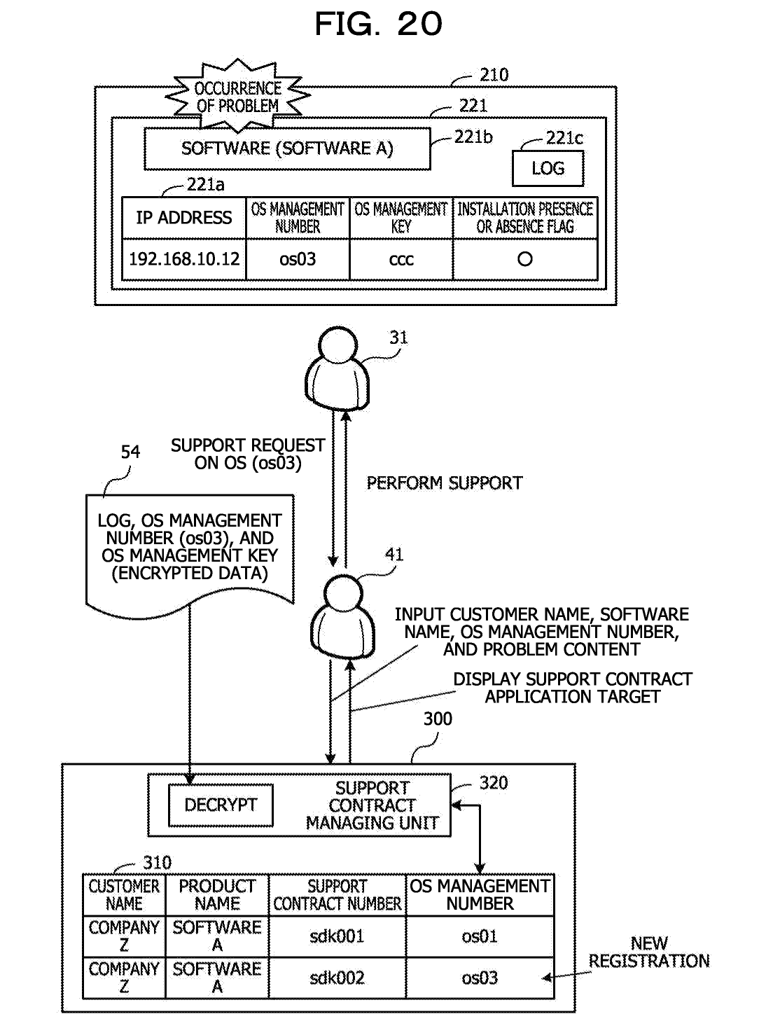

FIG. 20 is a diagram illustrating an example of dealing with a case where a problem occurs in different software from a support contract target. When a problem occurs in the software 221b installed on the OS 221 within the server 220, the user 31 makes a support request to the person 41 in charge of support, and notifies the customer name, the OS management number, and the software name. The user 31 then sends an encrypted file 54 to the person 41 in charge of support.

The person 41 in charge of support inputs the customer name, the OS management number, and the software name to the support contract managing server 300, and makes the support contract managing unit 320 decrypt the file 54. The support contract managing unit 320 confirms the log of the OS having the OS management number notified from the user 31 and the occurrence of the problem of the content notified from the user 31 based on the decrypted data. Next, with the customer name and the software name as a key, the support contract managing unit 320 obtains records of the support contracts corresponding to the key from the support contract information database 310. The support contract managing unit 320 then checks whether the obtained records of the support contracts include a record in which the field of the OS management number coincides with the OS management number notified from the user. In the example of FIG. 20, there is no such record. Accordingly, the support contract managing unit 320 checks whether the extracted records of the support contracts include a record in which the field of the OS management number is blank. In the example of FIG. 20, there is a record in which the field of the OS management number is blank.

The support contract managing unit 320 registers the OS management number input this time in the field of the OS management number in the record in which the field of the OS management number is blank. The support contract managing unit 320 then displays information indicating that the software having the problem is a target of application of a support contract. The person 41 in charge of support confirms that the software having the problem is a target of application of a support contract, and provides the user 31 with support for the software 221b.

The customer company 30 concludes only support contracts for two pieces of software. Thus, the two pieces of software that may be set as targets of the support contracts are identified by the processing of FIG. 20. The following description will be made of a case where a problem occurs in more pieces of software than the targets of the support contracts.

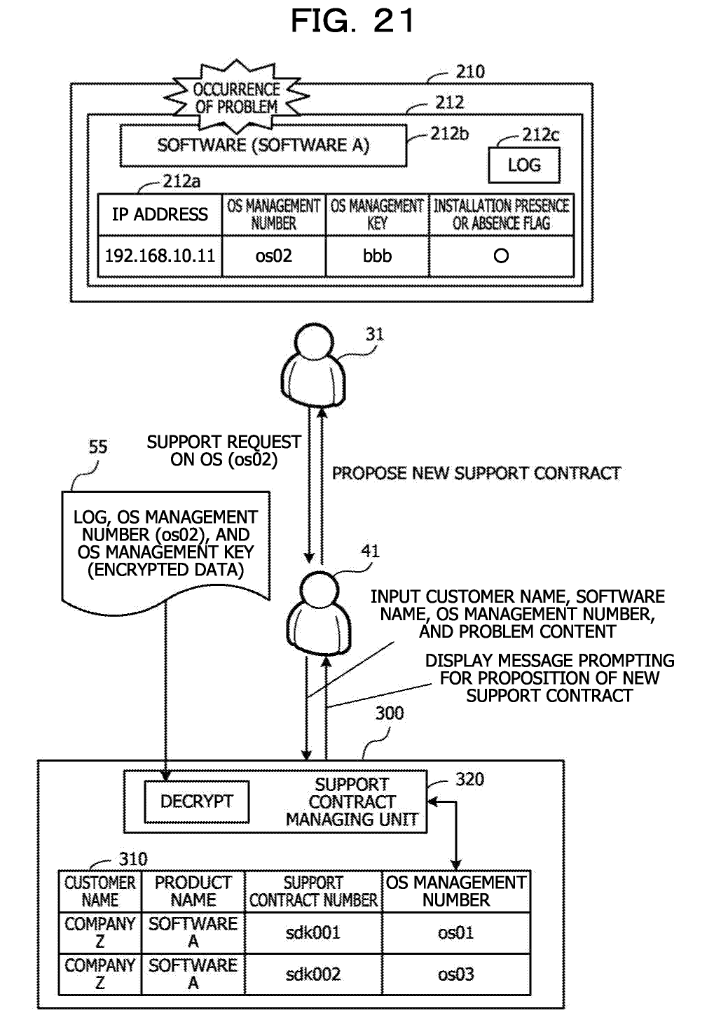

FIG. 21 is a diagram illustrating an example of dealing with a case where a problem occurs in more pieces of software than targets of support contracts. When a problem occurs in the software 212b installed on the OS 212 within the server 210, the user 31 makes a support request to the person 41 in charge of support, and notifies the customer name, the OS management number, and the software name. The user 31 then sends an encrypted file 55 to the person 41 in charge of support.

The person 41 in charge of support inputs the customer name, the OS management number, and the software name to the support contract managing server 300, and makes the support contract managing unit 320 decrypt the file 55. The support contract managing unit 320 confirms the log of the OS having the OS management number notified from the user 31 and the occurrence of the problem of the content notified from the user 31 based on the decrypted data. Next, with the customer name and the software name as a key, the support contract managing unit 320 obtains records of the support contracts corresponding to the key from the support contract information database 310. The support contract managing unit 320 then checks whether the obtained records of the support contracts include a record in which the field of the OS management number coincides with the OS management number notified from the user. In the example of FIG. 21, there is no such record. Accordingly, the support contract managing unit 320 checks whether the extracted records of the support contracts include a record in which the field of the OS management number is blank. In the example of FIG. 21, there is no record in which the field of the OS management number is blank. In this case, the support contract managing unit 320 displays a message prompting proposition of a new support contract. The person 41 in charge of support checks the message, and proposes conclusion of a new support contract to the user 31.

Thus, when a problem occurs in the more pieces of software than the targets of the support contracts, it is difficult for the user 31 to receive support for the software corresponding to an excess by which the number of support contracts is exceeded. In this case, there is a possibility of the user 31 falsifying the OS management number of the OS on which the software causing the problem is installed in order to receive support for the software corresponding to the excess by which the number of support contracts is exceeded. Description will next be made of dealing with a case where a user notifies a false OS management number, and makes a support request.

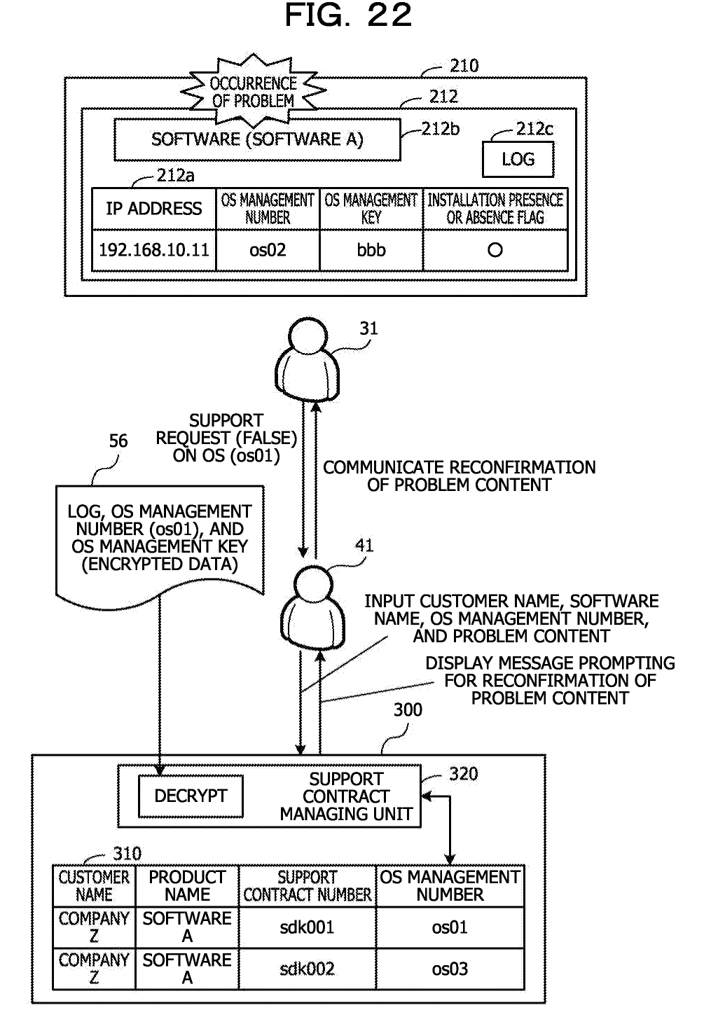

FIG. 22 is a diagram illustrating an example of dealing with a case where a false OS management number is notified to receive support. The example of FIG. 22 is a case where the user 31 makes a false communication indicating that a problem has occurred in the software 211b, which is already a target of a support contract, though the problem has occurred in the software 212b installed on the OS 212 within the server 210. The user 31 makes a support request to the person 41 in charge of support, and notifies the customer name, the false OS management number (os01), and the software name to the person 41 in charge of support. The user 31 then sends an encrypted file 56 to the person 41 in charge of support. The file 56 includes the log 211c of the software 211b in which no problem has occurred.

The person 41 in charge of support inputs the customer name, the OS management number, and the software name to the support contract managing server 300, and makes the support contract managing unit 320 decrypt the file 56. The support contract managing unit 320 confirms the log of the OS having the OS management number (os01) notified from the user 31. In the example of FIG. 22, however, no indication of the occurrence of a problem is found in the log. It is therefore difficult for the support contract managing unit 320 to confirm the occurrence of the problem of the content notified from the user 31. Accordingly, the support contract managing unit 320 displays a message prompting reconfirmation of the content of the problem. The person 41 in charge of support checks the message, and makes a communication requesting the user 31 to reconfirm the content of the problem.

Thus, even when the user 31 notifies a false OS management number, it is possible to avoid providing support for software in excess of the number of support contracts.

The above is a basic support contract managing method. By managing the support contracts by the above method, it is possible to identify individual software and associate the software with a support contract even when the software is installed on a virtual machine. For example, when the user 31 makes an inquiry to the person 41 in charge of support, the person 41 in charge of support may correctly determine whether the contents of the inquiry of the user are correct, and respond appropriately.

<Procedure of Dealing with Case Where Virtual Machine Together with OS Is Copied>

Description will next be made of a procedure of dealing with a case where a virtual machine together with an OS is copied.

A virtual machine is a pseudo computer system operating on a computer, and may be copied. When the copying is performed, the whole OS on the virtual machine is copied, and the whole of information identifying the individual OS is copied. The above-described support service providing procedure assigns an OS management number to each OS. However, when a virtual machine is copied, the managing server 100 recognizes a plurality of OSes having a same OS management number. As a result, OS management numbers are not associated with support contracts on a one-to-one basis.

In order to deal with such copying of a virtual machine, the second embodiment associates an OS management key with each OS separately from an OS management number. The managing server 100 updates the OS management key periodically or each time a given operation is performed. For example, as appropriate, the managing server 100 generates a new OS management key, and overwrites the registry of the OS and the OS information database 110 within the managing server 100 with the new OS management key. Thus, even when an OS is copied and branched into a plurality of OSes, the managing server may recognize each OS as a separate OS by referring to the OS management key, and assign a different OS management number to each OS again. As a result, even when a virtual machine is copied, support for a plurality of pieces of software under one support contract is suppressed.

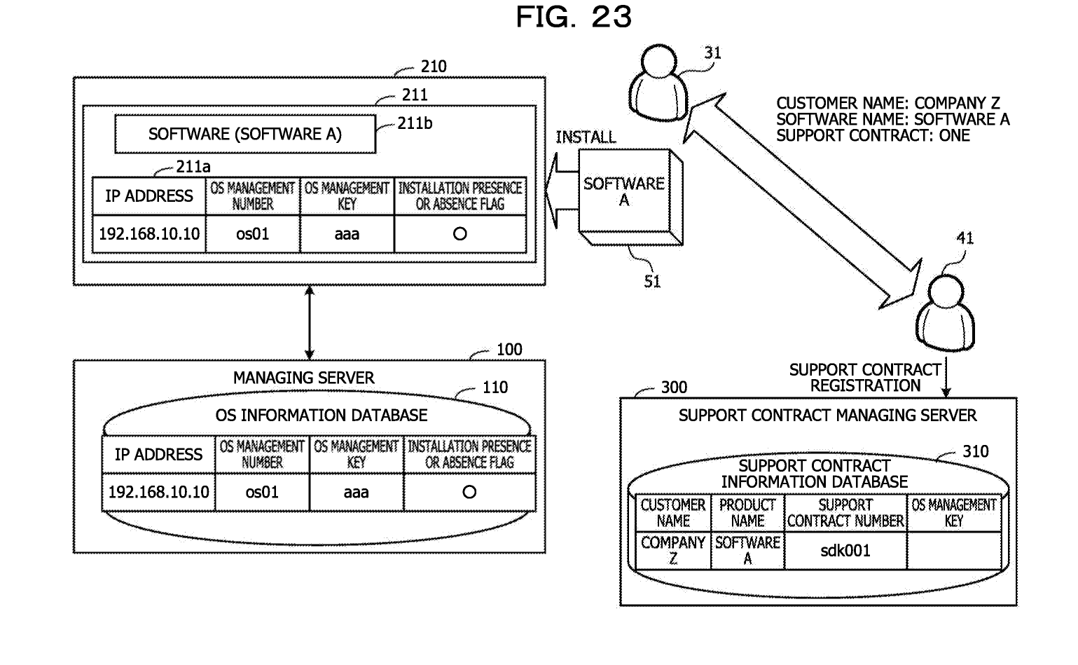

FIG. 23 is a diagram illustrating an example of an operation state before a virtual machine is copied. Suppose in the example of FIG. 23 that the management target software 211b is installed on the OS 211 within the server 210, and that no management target software is installed on the other OSes. In addition, OS information related to the OS 211 is already registered in the managing server 100. Further, a support contract for one piece of software is concluded between the customer company 30 and the service provider 40. The person 41 in charge of support then registers information related to the support contract in the support contract information database 310 of the support contract managing server 300.

Consideration will be given to a case where the virtual machine together with the OS is copied in such a state.

FIG. 24 is a diagram illustrating an example of a state after a virtual machine is copied. In the example of FIG. 24, a copy of the virtual machine within the server 210 executing the OS 211 is created on the server 220. As a result, the server 220 is executing an OS 223 having the same contents as the OS 211. For example, same software 223b as the software 211b installed on the OS 211 is installed on the OS 223. In the case where the log 211c of the software 211b is included in the OS 211, a log 223c having the same contents as the log 211c is included in the OS 223 as a copy destination.

Further, immediately after the copying, the same information as in the registry 211a of the OS 211 is set in a registry 223a of the OS 223. When even the IP address is the same, it is difficult to couple the two OSes 211 and 223 to the same network at the same time. Accordingly, the IP address of one OS (OS 223 as the copy destination in the example of FIG. 24) is changed.

Thus, as a result of copying the virtual machine, the OS 223 is generated which has the same OS management number and the same OS management key as the OS 211 executed on the virtual machine as a copy source. When this state is unchanged, it is difficult to identify software support targets. Accordingly, the managing server 100 periodically updates the OS management key.

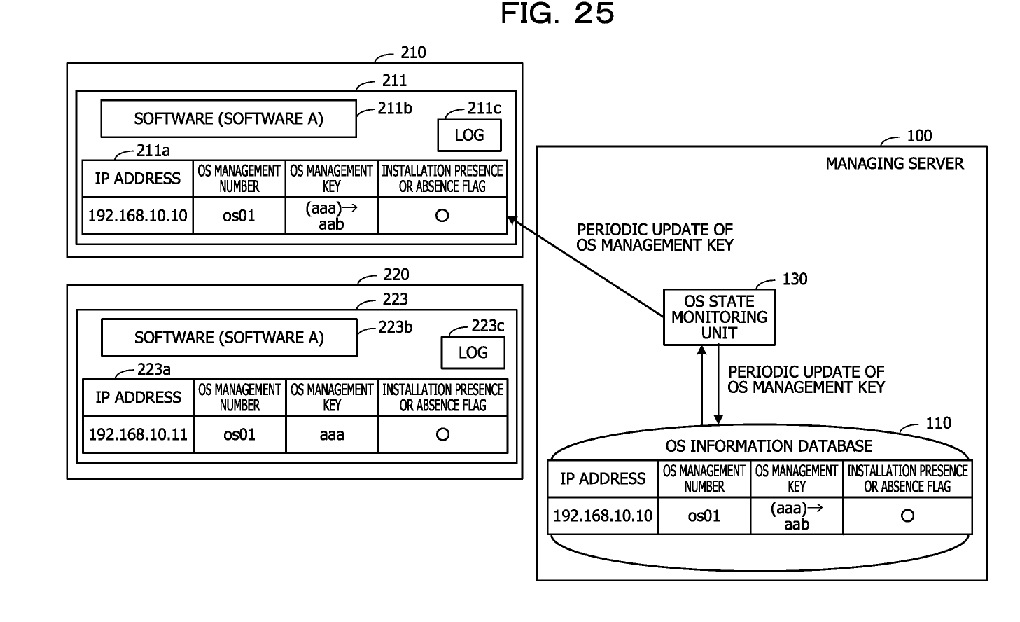

FIG. 25 is a diagram illustrating an example of conditions of periodic update of an OS management key. The OS state monitoring unit 130 periodically performs the following processing at set time intervals.

The OS state monitoring unit 130 first obtains a record indicating the information of the already registered OS from the OS information database 110. The OS state monitoring unit 130 next writes a new OS management key to the registry 211a of the OS 211 corresponding to the IP address indicated in the obtained record. In the example of FIG. 25, the OS management key is updated from “aaa” to “aab.” The OS state monitoring unit 130 further writes the OS management key newly set in the OS 211 to the field of the OS management key in the corresponding record within the OS information database 110.

The second embodiment thus periodically updates the OS management key of the OS recognized by the managing server 100 based on the information of the OS registered in the OS information database 110. Therefore, even when the virtual machine is copied, the OS as the copy source and the OS as the copy destination may be distinguished from each other based on the OS management keys.

The OS management key is updated also when information of a new OS is registered in the managing server 100, for example.

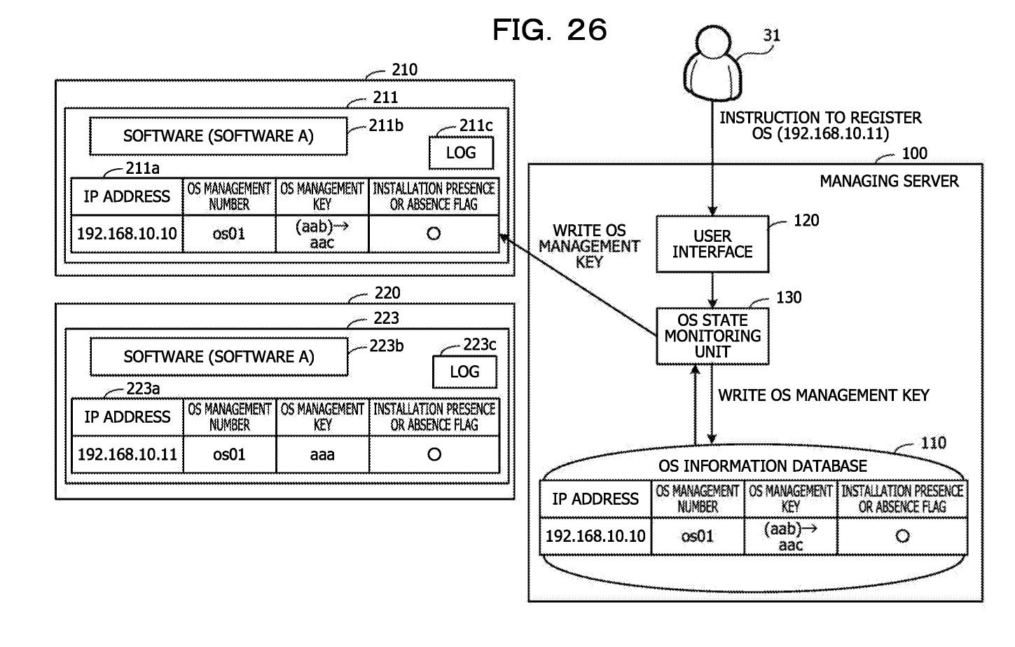

FIG. 26 is a first diagram illustrating an example of conditions of registration of other OS information in a case where OS information is already registered. The user 31 inputs, to the user interface 120, an instruction to register the OS 223 on which the software 223b as a management target is installed. The registering instruction includes the IP address of the OS 223. The input registering instruction is received by the user interface 120, and transferred to the OS state monitoring unit 130.

Receiving the registering instruction, the OS state monitoring unit 130 first obtains the record indicating the already registered OS information from the OS information database 110. The OS state monitoring unit 130 writes a new OS management key to the registry 211a of the OS 211 corresponding to the IP address indicated in the obtained record. In the example of FIG. 26, the OS management key is updated from “aab” to “aac.” The OS state monitoring unit 130 further writes the OS management key newly set in the OS 211 to the field of the OS management key in the corresponding record within the OS information database 110.

OS information registration processing according to the registering instruction is thereafter performed.

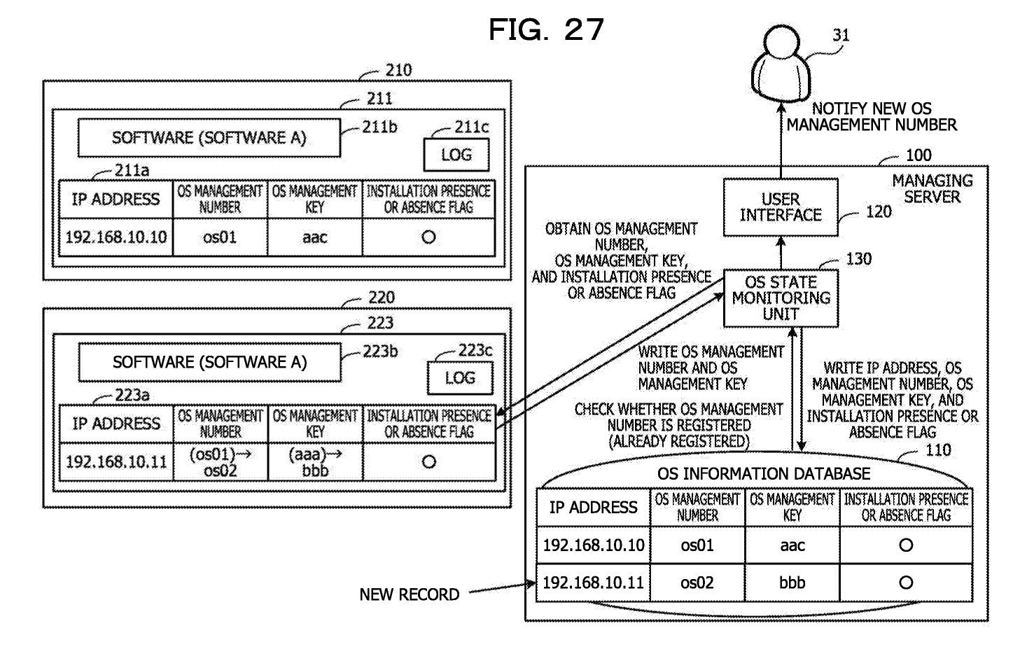

FIG. 27 is a second diagram illustrating an example of conditions of registration of other OS information in a case where OS information is already registered. The OS state monitoring unit 130 first obtains pieces of information including an OS management number, an OS management key, and an installation presence or absence flag from the registry 223a of the OS 223 as a management target. In this stage, information within the registry 223a illustrated in FIG. 26 is obtained. Next, the OS state monitoring unit 130 refers to the OS information database 110, and checks whether the obtained OS management number is already registered or not. In the example of FIG. 27, the obtained OS management number is registered in the checking stage.

When the OS management number is registered in the OS information database 110, the OS state monitoring unit 130 checks whether the OS management key within the registry 223a and the OS management key included in the record registered in the OS information database 110 coincide with each other. In the example of FIG. 27, the OS management keys do not coincide with each other. In this case, the OS state monitoring unit 130 notifies the user 31 via the user interface 120 that the OS management number within the registry 223a is to become a new OS management number.

Then, the OS state monitoring unit 130 generates a new OS management number and a new OS management key, and writes the new OS management number and the new OS management key to the registry 223a of the OS 223. Further, the OS state monitoring unit 130 registers, in the OS information database 110, a new record including information related to the software 223b, the information being registered in the registry 223a of the OS 223. In the example of FIG. 27, a record in which the IP address “192.168.10.11” of the OS 223, an OS management number “os02,” an OS management key “bbb,” and an installation presence or absence flag “o” are set is registered in the OS information database 110.

Thus, when an OS information registering instruction is input to the managing server 100, the OS management key of an OS indicated by already registered OS information is updated.

Incidentally, in the processing illustrated in FIG. 27, while the OS management number of the OS as the copy destination is changed to a newly generated value, the OS management number of the OS as the copy source is not changed. However, depending on a mode of operation, conversely, the OS management number of the OS as the copy source may be changed to a newly generated value, and the OS management number of the OS as the copy destination may not be changed. As a case where the OS management number of the OS as the copy source is changed, there is, for example, a case where power to the server including the virtual machine of the copy source is turned off after the virtual machine is copied.

The following description will be made of processing in the case where the OS management number of the OS as the copy source is changed, assuming a case where the power to the server including the OS as the copy source is shut off after the virtual machine is copied as illustrated in FIG. 24 and before the OS management key is updated.

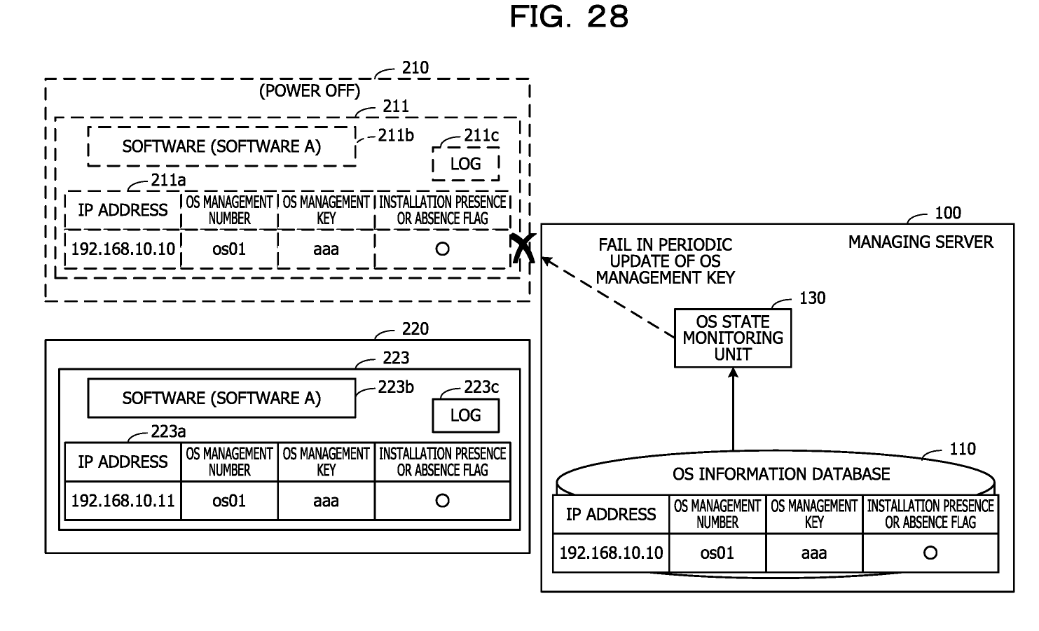

FIG. 28 is a diagram illustrating an example of conditions of periodic update of OS management keys after power to a server including an OS as a copy source is shut off. The OS state monitoring unit 130 first obtains a record indicating the information of the already registered OS from the OS information database 110. The OS state monitoring unit 130 next attempts to write a new OS management key to the registry 211a of the OS 211 corresponding to the IP address indicated in the obtained record. However, the power to the server 210 is shut off, and thus it is difficult for the OS state monitoring unit 130 to access the registry 211a of the OS 211. Therefore, the writing of the OS management key has failed, and the processing of periodic update of the OS management key is ended without the OS management key being updated.

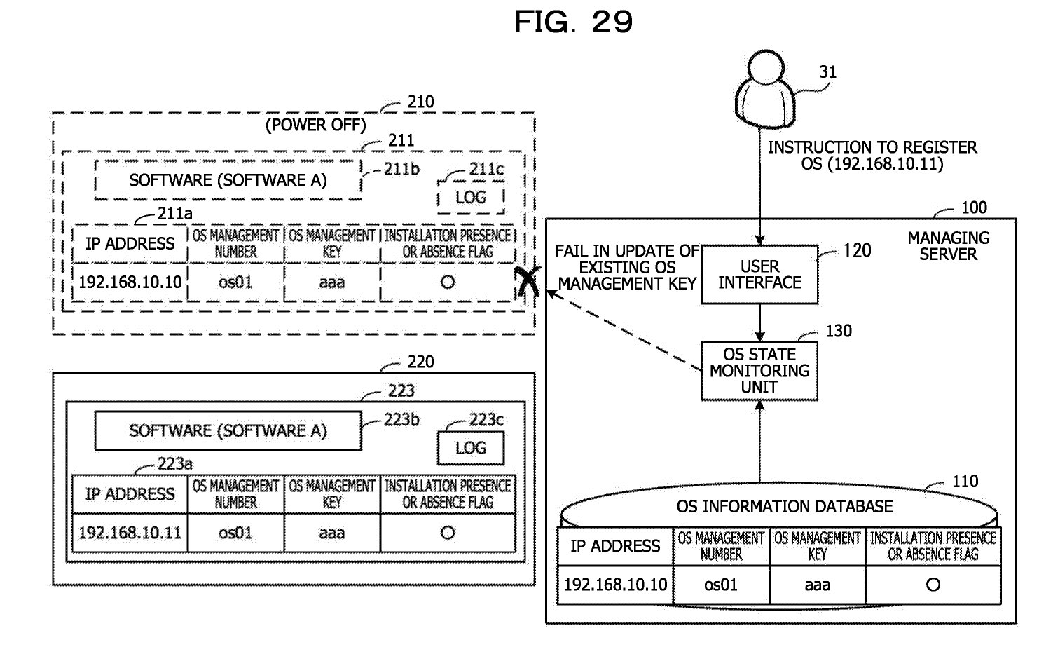

FIG. 29 is a first diagram illustrating an example of conditions of update of OS management keys, update accompanying registration of OS information after shutting off power to a server including an OS as a copy source. The user 31 inputs, to the user interface 120, an instruction to register the OS 223 on which the software 223b as a management target is installed. The registering instruction includes the IP address of the OS 223. The input registering instruction is received by the user interface 120, and transferred to the OS state monitoring unit 130.

Receiving the registering instruction, the OS state monitoring unit 130 first obtains the record indicating the already registered OS information from the OS information database 110. The OS state monitoring unit 130 attempts to write a new OS management key to the registry 211a of the OS 211 corresponding to the IP address indicated in the obtained record. However, the power to the server 210 is shut off, and thus it is difficult for the OS state monitoring unit 130 to access the registry 211a of the OS 211. Therefore, the writing of the OS management key has failed, and OS information registration processing according to the registering instruction is performed without the OS management key being updated.

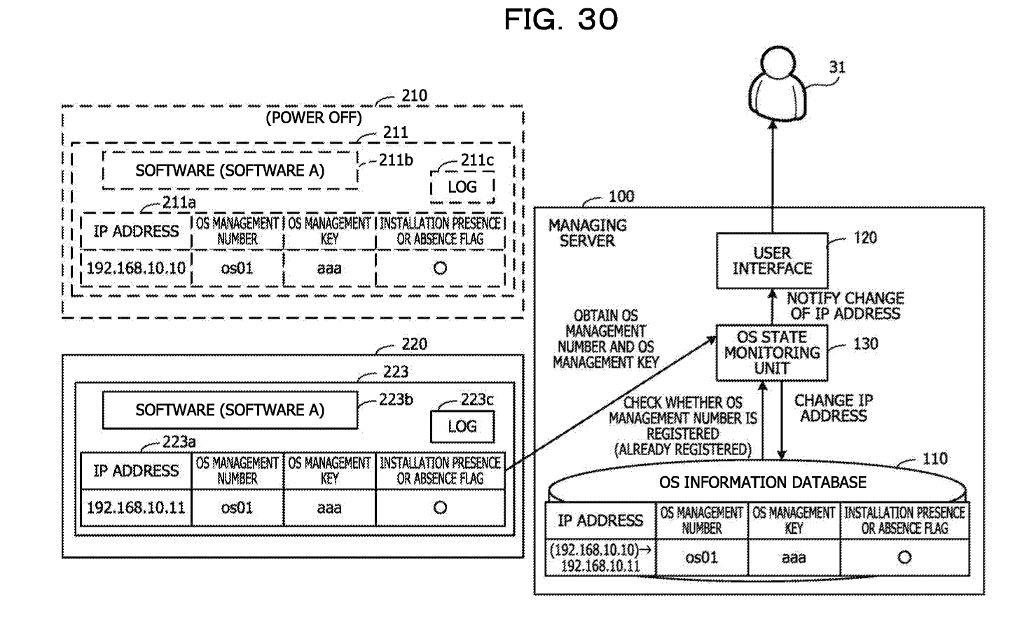

FIG. 30 is a second diagram illustrating an example of conditions of update of OS management keys, update accompanying registration of OS information after shutting off power to a server including an OS as a copy source. The OS state monitoring unit 130 first obtains pieces of information including an OS management number, an OS management key, and an installation presence or absence flag from the registry 223a of the OS 223 as a management target. Next, the OS state monitoring unit 130 refers to the OS information database 110, and checks whether the obtained OS management number is already registered or not. In the example of FIG. 30, the obtained OS management number is already registered.

When the obtained OS management number is registered in the OS information database 110, the OS state monitoring unit 130 checks whether the OS management key in the record including the OS management number and the OS management key obtained from the OS 223 coincide with each other. In the example of FIG. 30, the OS management keys coincide with each other. When the OS management keys coincide with each other, the OS state monitoring unit 130 determines that the specified OS information is already registered, and does not make a new registration.

However, the IP address “192.168.10.11” of the OS 223 and the IP address “192.168.10.10” set in the record indicating the information of the OS 223 registered in the OS information database 110 are different from each other. Accordingly, the OS state monitoring unit 130 changes the IP address of the record to “192.168.10.11.” The OS state monitoring unit 130 then notifies the user interface 120 that the registered IP address is changed. The user interface 120 displays information indicating that the registered IP address is changed on the monitor 21.

The managing server 100 thereafter recognizes that the OS corresponding to the OS management key “aaa” is the OS 223 as the copy destination. Suppose that OS management key periodic update is subsequently performed while the power to the server 210 remains shut off.

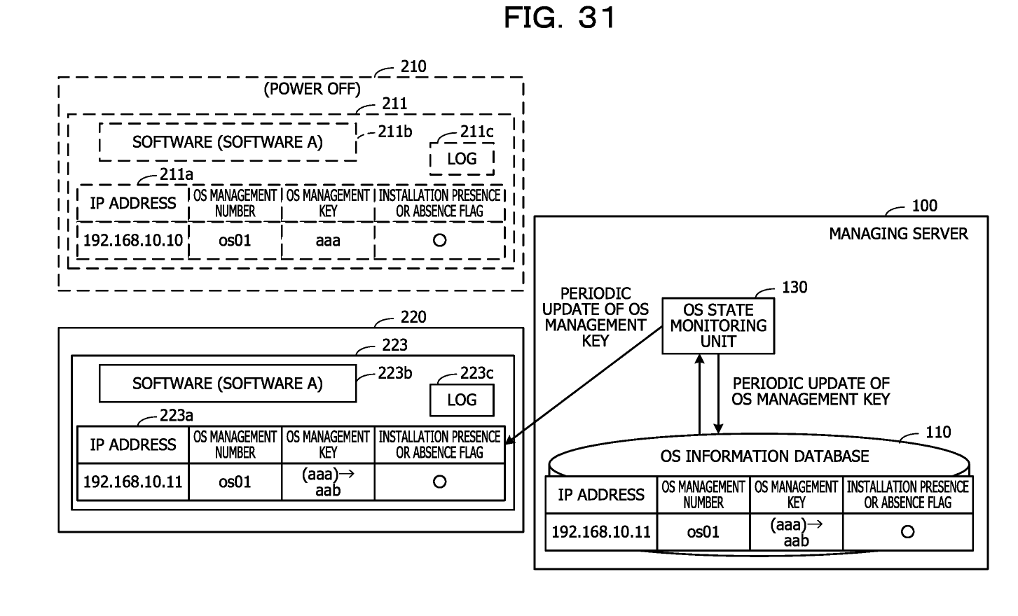

FIG. 31 is a diagram illustrating an example of conditions of periodic update of OS management keys after assignment of registered OS information to an OS as a copy destination. The OS state monitoring unit 130 obtains a record indicating the information of the already registered OS from the OS information database 110. The OS state monitoring unit 130 next writes a new OS management key to the registry 223a of the OS 223 corresponding to the IP address indicated in the obtained record. In the example of FIG. 31, the OS management key is updated from “aaa” to “aab.” The OS state monitoring unit 130 further writes the OS management key newly set in the OS 223 to the field of the OS management key in the corresponding record within the OS information database 110.

Suppose that, thereafter, the power to the server 210 is turned on, and the OS 211 is started. As a result of the processing illustrated in FIG. 30, the record registered in the OS information database 110 now indicates the OS information of the OS 223. Accordingly, the user 31 inputs, to the managing server 100, an instruction to register the OS 211 after completion of the start of the OS 211.

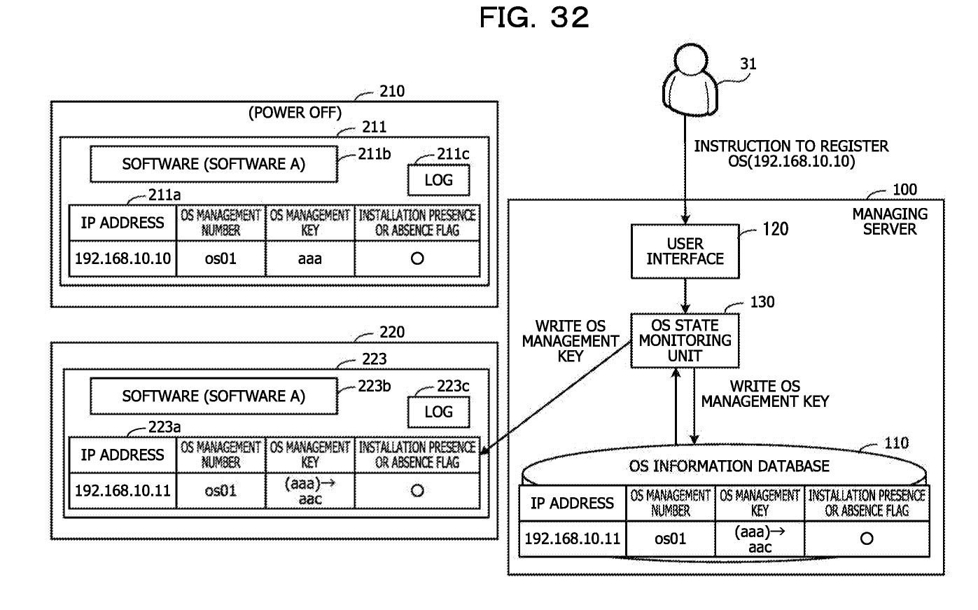

FIG. 32 is a first diagram illustrating an example of conditions of registration of OS information after a restart of an OS as a copy source. The user 31 inputs, to the user interface 120, an instruction to register the OS 211 on which the software 211b as a management target is installed. The registering instruction includes the IP address of the OS 211. The input registering instruction is received by the user interface 120, and transferred to the OS state monitoring unit 130.

Receiving the registering instruction, the OS state monitoring unit 130 first obtains a record indicating the already registered OS information from the OS information database 110. The OS state monitoring unit 130 writes a new OS management key to the registry 223a of the OS 223 corresponding to the IP address indicated in the obtained record. In the example of FIG. 32, the OS management key is updated from “aab” to “aac.” The OS state monitoring unit 130 further writes the OS management key newly set in the OS 223 to the field of the OS management key in the corresponding record within the OS information database 110.

OS information registration processing according to the registering instruction is thereafter performed.

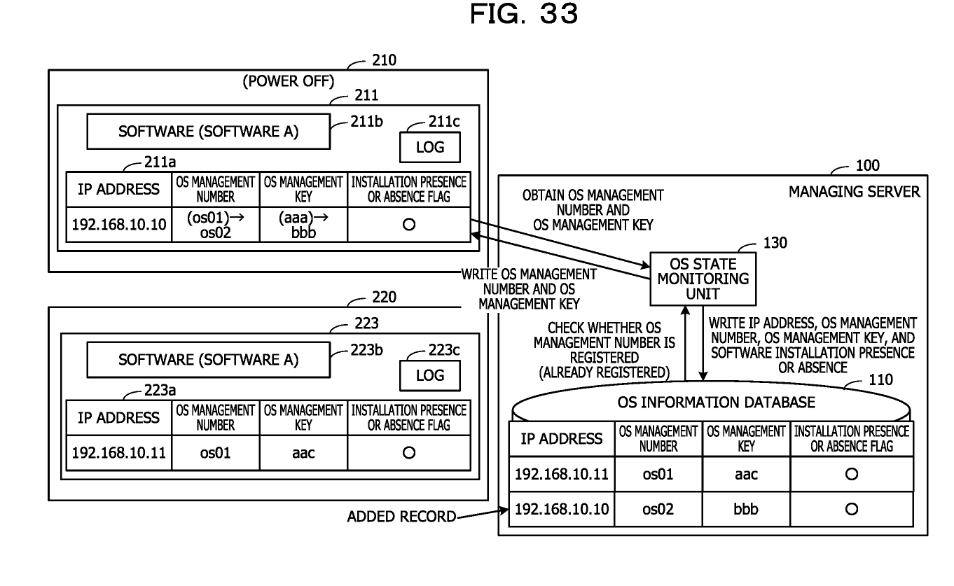

FIG. 33 is a second diagram illustrating an example of conditions of registration of OS information after a restart of an OS as a copy source. The OS state monitoring unit 130 first obtains pieces of information including an OS management number, an OS management key, and an installation presence or absence flag from the registry 211a of the OS 211 as a management target. Next, the OS state monitoring unit 130 refers to the OS information database 110, and checks whether the obtained OS management number is already registered or not. In the example of FIG. 33, the obtained OS management number is registered in the checking stage.

When the OS management number is registered in the OS information database 110, the OS state monitoring unit 130 generates a new OS management number and a new OS management key, and writes the new OS management number and the new OS management key to the registry 211a of the OS 211. The OS state monitoring unit 130 further registers, in the OS information database 110, a new record including information related to the software 211b, the information being registered in the registry 211a of the OS 211. In the example of FIG. 33, a record in which the IP address “192.168.10.10” of the OS 211, an OS management number “os02,” an OS management key “bbb,” and an installation presence or absence flag “o” are set is registered in the OS information database 110.

Thus, when the copying of a virtual machine results in the presence of a plurality of OSes having a same OS management number and a same OS management key, the managing server 100 recognizes that the OS whose information may be obtained first is an already recognized OS. The managing server 100 then recognizes the OS whose information is obtained afterward as a new OS.

By thus combining an OS management number with an OS management key, and updating the recognized OS management key as appropriate, it is possible to distinguish an OS as a copy source and an OS as a copy destination even when a virtual machine together with the OS is copied.

### <Overall Processing Procedure>

A series of processing procedures in the second embodiment will be described more concretely in the following. Incidentally, suppose that the following are already completed: installation of software onto OSes corresponding in number to the number of licenses; and conclusion of support contracts for the software between the customer company 30 and the service provider 40.

A processing procedure at a time of registering OS information in the managing server 100 will first be described in detail.

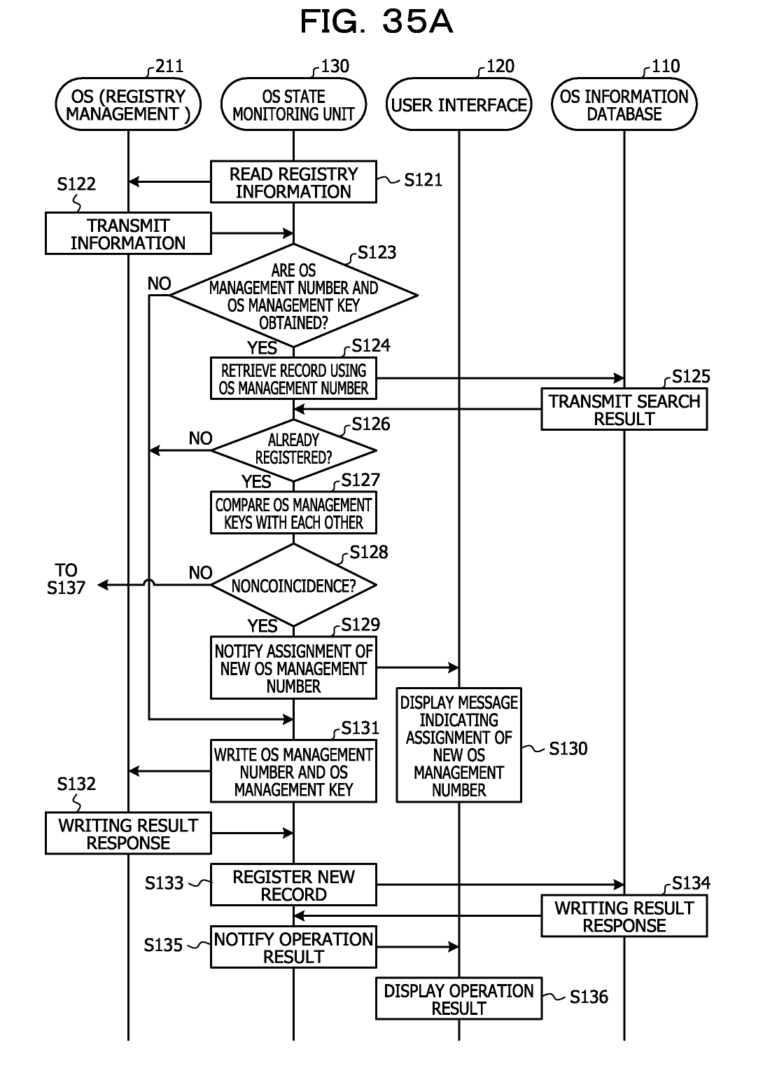

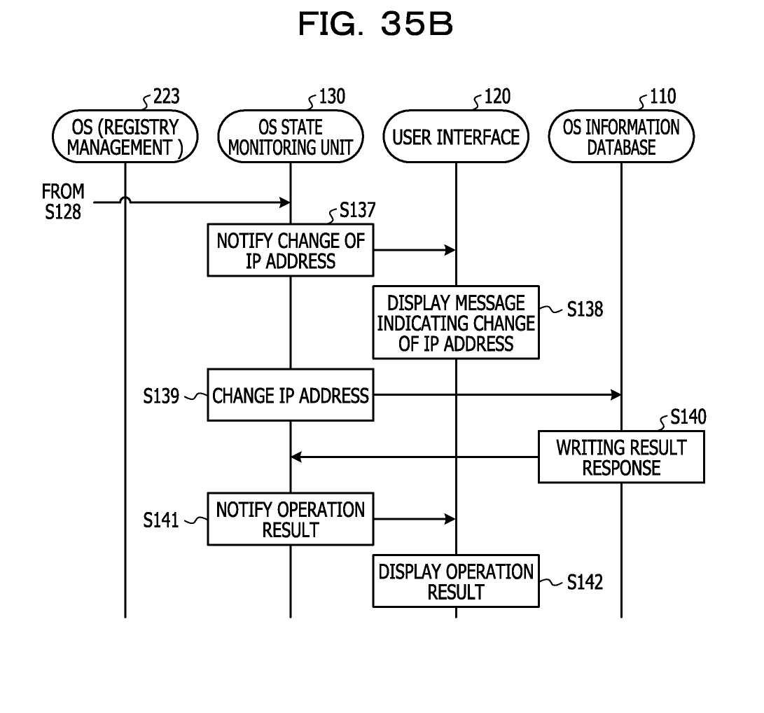

FIG. 34 is a sequence diagram illustrating a first half of a procedure of OS information registration processing. The processing illustrated in FIG. 34 will be described in the following along step numbers.

[Step S101] The user interface 120 obtains an OS registering instruction input by the user 31. The OS registering instruction includes the IP address of an OS to be registered.

[Step S102] The user interface 120 transfers the obtained OS registering instruction to the OS state monitoring unit 130.

[Step S103] Receiving the OS registering instruction, the OS state monitoring unit 130 transmits a request to call up all records indicating OS information to the OS information database 110.

[Step S104] The OS information database 110 transmits all of the records indicating OS information to the OS state monitoring unit 130.

[Step S105] The OS state monitoring unit 130 determines whether or not there is OS information in the OS information database 110. For example, the OS state monitoring unit 130 determines that there is OS information when receiving at least one record from the OS information database 110. In addition, the OS state monitoring unit 130 determines that there are no OS information when receiving no record from the OS information database 110. When there is OS information, the OS state monitoring unit 130 advances the processing to step S106. In addition, when there is no OS information, the OS state monitoring unit 130 advances the processing to step S121 (see FIG. 35A).

[Step S106] The OS state monitoring unit 130 performs the processing of steps S107 to S110 the number of times corresponding to the number of OS information records obtained. For example, the OS state monitoring unit 130 selects the records obtained from the OS information database 110 one by one, and performs the processing of steps S107 to S110 for a selected record. In the example of FIG. 34, the processing in a case where a record indicating the OS information of the OS 211 may be obtained is illustrated in steps S107 to S110.

[Step S107] The OS state monitoring unit 130 generates a new OS management key, and writes the generated OS management key to the registry 211a of the OS 211 corresponding to the selected record. For example, the OS state monitoring unit 130 transmits, to the OS 211, a request to write the OS management key to the registry 211a.

[Step S108] The OS 211 responds by notifying a result of writing to the registry 211a to the OS state monitoring unit 130. For example, when the writing has succeeded, the OS 211 responds by notifying normal ending of a writing command. In addition, when the writing has failed, the OS 211 responds by notifying an error message indicating the writing failure.

[Step S109] The OS state monitoring unit 130 determines whether or not the writing has succeeded based on the response of the writing result. For example, when the OS state monitoring unit 130 receives the response of a writing success from the OS 211, the OS state monitoring unit 130 determines that the writing has succeeded. In addition, when the OS state monitoring unit 130 receives the response of an error message, or when the OS state monitoring unit 130 fails in communication coupling to the OS 211, the OS state monitoring unit 130 determines that the writing has failed. When the writing has succeeded, the OS state monitoring unit 130 advances the processing to step S110. In addition, when the writing has failed, the OS state monitoring unit 130 advances the processing to step S112.

[Step S110] The OS state monitoring unit 130 writes the OS management key written to the registry 211a of the OS 211 to the record indicating the OS information of the OS 211 within the OS information database 110.

[Step S111] After writing the OS management key, the OS information database 110 transmits a writing result response indicating a success of the writing to the OS state monitoring unit 130.

[Step S112] When the OS state monitoring unit 130 completes the processing on all of the records obtained from the OS information database 110, the OS state monitoring unit 130 advances the processing to step S121 (see FIG. 35A).

FIGS. 35A and 35B are a sequence diagram illustrating a second half of a procedure of OS information registration processing. The processing illustrated in FIGS. 35A and 35B will be described in the following along step numbers. Incidentally, suppose that an OS registering instruction includes the IP address of the OS 223.

[Step S121] The OS state monitoring unit 130 obtains pieces of information including an OS management number, an OS management key, and an installation presence or absence flag from the registry 223a of the OS 223. For example, the OS state monitoring unit 130 transmits, to the OS 223, a request to read the OS management number, the OS management key, and the installation presence or absence flag within the registry 223a.

[Step S122] In response to the reading request, the OS 223 transmits, to the OS state monitoring unit 130, pieces of information including the OS management number, the OS management key, and the installation presence or absence flag within the registry 223a. Incidentally, the OS management number and the OS management key are already set in the OS 223 at the time of the OS registering instruction in the case of the copying of another OS, as illustrated in FIG. 24. In other than the case of the copying of another OS, on the other hand, the OS management number and the OS management key are not set yet. When the OS management number and the OS management key are not set in the registry 223a yet, the OS 223 transmits only the installation presence or absence flag to the OS state monitoring unit 130.

[Step S123] The OS state monitoring unit 130 determines whether or not the OS management number and the OS management key are obtained. When the OS management number and the OS management key are obtained, the OS state monitoring unit 130 advances the processing to step S124. In addition, when the OS management number and the OS management key are not obtained, the OS state monitoring unit 130 advances the processing to step S131.

[Step S124] The OS state monitoring unit 130 retrieves, from the OS information database 110, a record including the OS management number obtained from the OS 223.

[Step S125] The OS information database 110 transmits a record including the specified OS management number as a result of the retrieval to the OS state monitoring unit 130. Incidentally, when there is no corresponding record, the OS information database 110 transmits, to the OS state monitoring unit 130, a response indicating that there is no corresponding record.

[Step S126] The OS state monitoring unit 130 determines whether or not the OS management number obtained from the OS 223 is registered in the OS information database 110. For example, the OS state monitoring unit 130 determines that the OS management number obtained from the OS 223 is registered when the OS state monitoring unit 130 finds a corresponding record by searching the OS information database 110. When the OS management number obtained from the OS 223 is registered, the OS state monitoring unit 130 advances the processing to step S127. In addition, when the OS management number obtained from the OS 223 is not registered yet, the OS state monitoring unit 130 advances the processing to step S131.

[Step S127] The OS state monitoring unit 130 checks whether or not the OS management key obtained from the OS 223 and an OS management key included in the record obtained from the OS information database 110 coincide with each other.

[Step S128] When the OS management keys coincide with each other, the OS state monitoring unit 130 advances the processing to step S137. In addition, when the OS management keys do not coincide with each other, the OS state monitoring unit 130 advances the processing to step S129.

[Step S129] The OS state monitoring unit 130 notifies the user interface 120 of information indicating assignment of a new OS management number.

[Step S130] The user interface 120 displays a message indicating assignment of a new OS management number on the monitor 21.

[Step S131] The OS state monitoring unit 130 writes an OS management number and an OS management key to the registry 223a of the OS 223.

[Step S132] The OS 223 transmits the response of a result of writing the OS management number and the OS management key to the OS state monitoring unit 130.

[Step S133] The OS state monitoring unit 130 registers a new record in the OS information database 110. The registered record includes the IP address of the OS 223, the OS management number and the OS management key written in step S131, and the installation presence or absence flag obtained in the processing of steps S121 and S122.

[Step S134] After writing the record, the OS information database 110 transmits the response of a writing result to the OS state monitoring unit 130.

[Step S135] The OS state monitoring unit 130 notifies the operation result to the user interface 120.

[Step S136] The user interface 120 displays the notified operation result on the monitor 21.

When it is determined in step S128 that the OS management keys do not coincide with each other, the OS information registration processing is then ended. The following is processing in a case where it is determined in step S128 that the OS management keys coincide with each other.

[Step S137] The OS state monitoring unit 130 notifies a change of the IP address to the user interface 120.

[Step S138] The user interface 120 displays a message to the effect that the IP address is to be changed on the monitor 21.

[Step S139] The OS state monitoring unit 130 changes the IP address of the record hit in the search of step S124 in the OS information database 110 to the IP address included in the obtained OS information registering instruction.

[Step S140] The OS information database 110 writes the IP address after the change to the record, and transmits the response of a writing result to the OS state monitoring unit 130.

[Step S141] The OS state monitoring unit 130 notifies the operation result to the user interface 120.

[Step S142] The user interface 120 displays the notified operation result on the monitor 21.

Thus, according to the OS information registering instruction, the OS information of the OS indicated by the registering instruction is registered in the OS information database 110.

Description will next be made of processing of periodically obtaining information indicating the presence or absence of an installation.

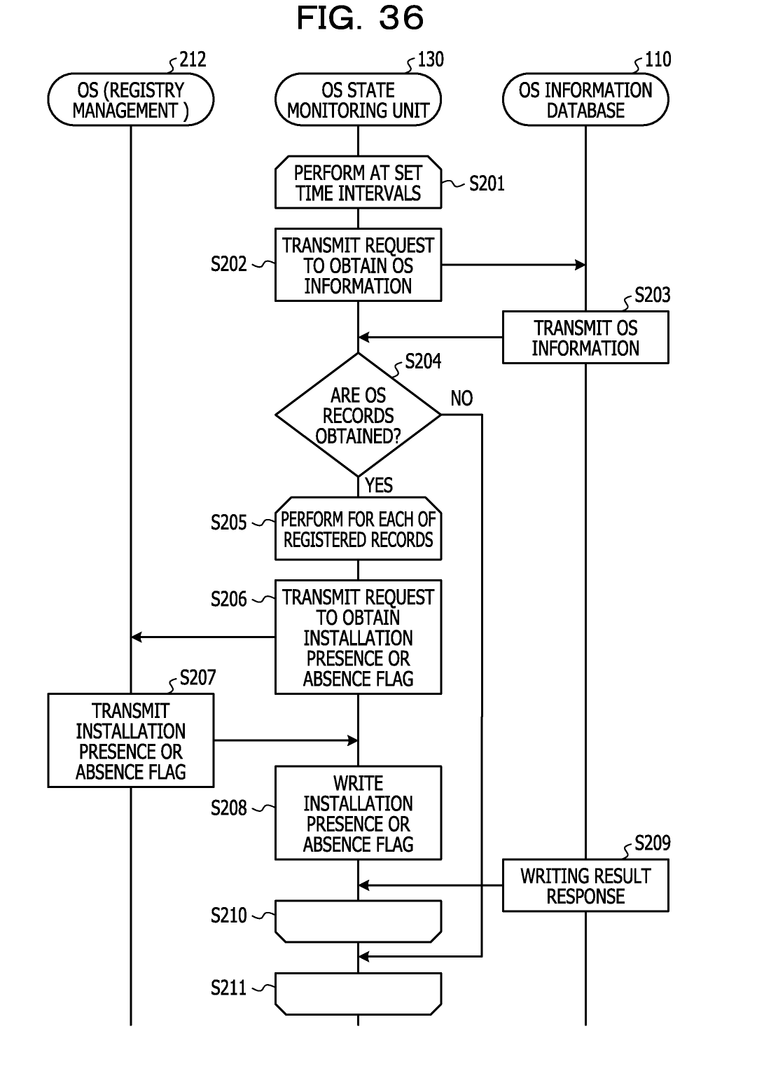

FIG. 36 is a sequence diagram illustrating an example of a procedure of installation information periodic obtainment processing. The processing illustrated in FIG. 36 will be described in the following along step numbers.

[Step S201] The OS state monitoring unit 130 performs the processing of steps S202 to S210 at preset time intervals.

[Step S202] The OS state monitoring unit 130 transmits a request to obtain records indicating registered OS information to the OS information database 110.

[Step S203] The OS information database 110 transmits the records indicating the OS information to the OS state monitoring unit 130.

[Step S204] The OS state monitoring unit 130 determines whether or not the records of the OS information are obtained. When the records are obtained, the OS state monitoring unit 130 advances the processing to step S205. In addition, when the records are not obtained, the OS state monitoring unit 130 advances the processing to step S211.

[Step S205] The OS state monitoring unit 130 performs the processing of steps S206 to S210 for each of the records registered in the OS information database 110.

The following description will be made of the processing of steps S206 to S209, supposing that the processing is performed for a record indicating the information of the OS 212.

[Step S206] The OS state monitoring unit 130 transmits, to the OS 212, a request to obtain an installation presence or absence flag within the registry 212a of the OS 212 corresponding to the record as a processing target.

[Step S207] The OS 212 transmits the installation presence or absence flag within the registry 212a to the OS state monitoring unit 130.

[Step S208] The OS state monitoring unit 130 transmits, to the OS information database 110, a request to write the installation presence or absence flag obtained from the OS 212 to the record corresponding to the OS 212.

[Step S209] The OS information database 110 writes the installation presence or absence flag, and transmits a response indicating a result of the writing to the OS state monitoring unit 130.

[Step S210] When the processing is completed for all of the records obtained from the OS information database 110, the OS state monitoring unit 130 advances the processing to step S211.

[Step S211] The OS state monitoring unit 130 ends performing the iterative processing of steps S202 to S210 when the user 31, for example, inputs an instruction to end the installation information periodic obtainment processing.

Thus, as illustrated in FIG. 14, for example, information indicating whether or not software is installed on each server is obtained by the managing server 100, and reflected in the OS information database 110.

Description will next be made of a processing procedure for periodic update of OS management keys.

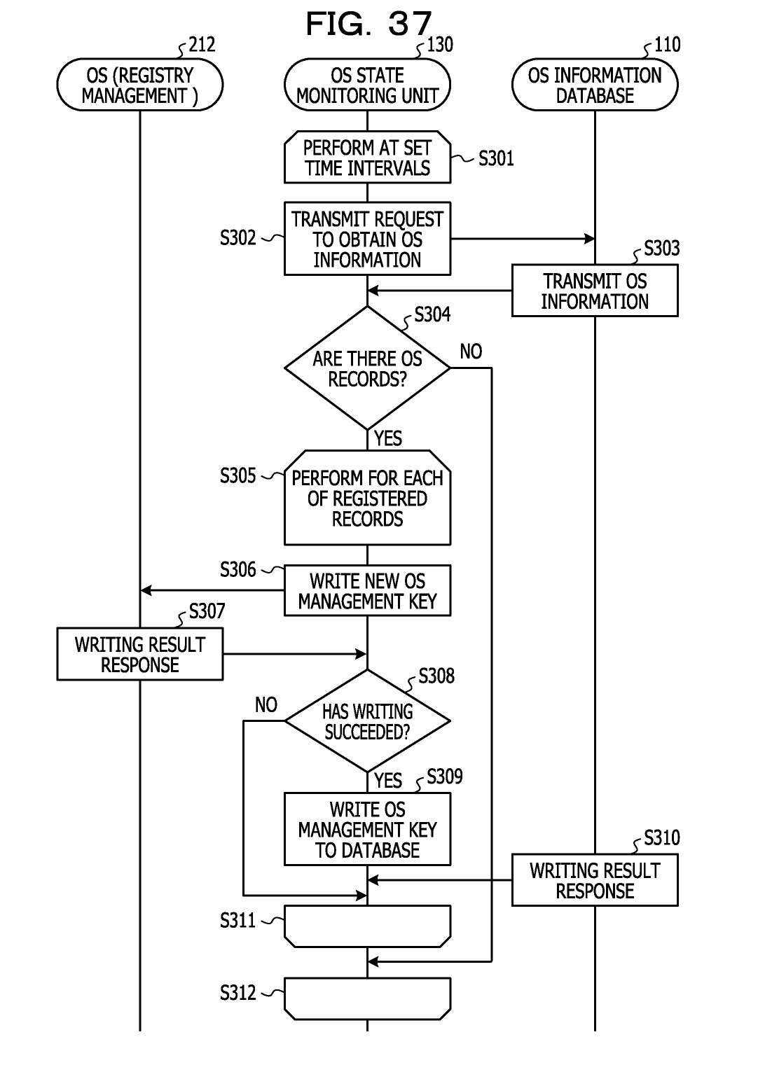

FIG. 37 is a sequence diagram illustrating an example of a procedure of OS management key periodic update processing. The processing illustrated in FIG. 37 will be described in the following along step numbers.

[Step S301] The OS state monitoring unit 130 performs the processing of steps S302 to S311 at preset time intervals.

[Step S302] The OS state monitoring unit 130 transmits a request to obtain records indicating registered OS information to the OS information database 110.

[Step S303] The OS information database 110 transmits the records indicating the OS information to the OS state monitoring unit 130.

[Step S304] The OS state monitoring unit 130 determines whether or not the records of the OS information are obtained. When the records are obtained, the OS state monitoring unit 130 advances the processing to step S305. In addition, when the records are not obtained, the OS state monitoring unit 130 advances the processing to step S312.

[Step S305] The OS state monitoring unit 130 performs the processing of steps S306 to S310 for each of the records registered in the OS information database 110.

The following description will be made of the processing of steps S306 to S309, supposing that the processing is performed for a record indicating the information of the OS 211.

[Step S306] The OS state monitoring unit 130 generates a new OS management key, and transmits, to the OS 211, a request to write the new OS management key to the registry 211a of the OS 211.

[Step S307] The OS 211 writes the OS management key to the registry 211a, and transmits a response indicating a result of the writing to the OS state monitoring unit 130.

[Step S308] The OS state monitoring unit 130 determines whether or not the writing of the OS management key has succeeded. When the writing has succeeded, the OS state monitoring unit 130 advances the processing to step S309. In addition, when the writing has failed, the OS state monitoring unit 130 advances the processing to step S311.

[Step S309] The OS state monitoring unit 130 transmits, to the OS information database 110, a request to write the new OS management key to the record corresponding to the OS 211.

[Step S310] The OS information database 110 writes the OS management key, and transmits a response indicating a result of the writing to the OS state monitoring unit 130.

[Step S311] When the processing is completed for all of the records obtained from the OS information database 110, the OS state monitoring unit 130 advances the processing to step S312.

[Step S312] The OS state monitoring unit 130 ends performing the iterative processing of steps S302 to S311 when the user 31, for example, inputs an instruction to end the OS management key periodic obtainment processing.

Thus, the OS management key of each OS is periodically updated.

Description will next be made of processing in a case where a problem occurs in software, and support service is requested. When support service is requested, the system on the customer company 30 side performs OS management number identification processing and encrypted file generation processing.

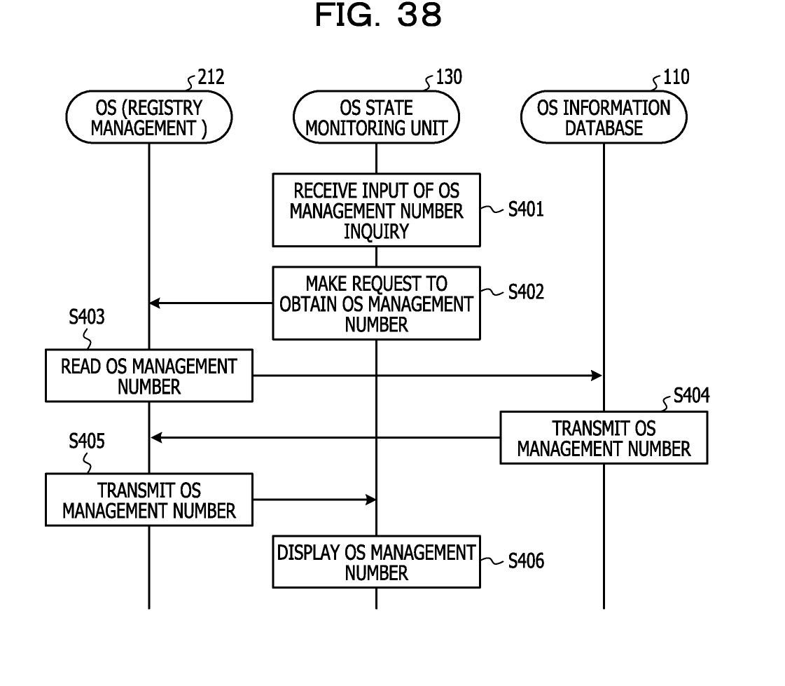

FIG. 38 is a flowchart illustrating an example of a procedure of OS management number identification processing. The processing illustrated in FIG. 38 will be described in the following along step numbers.

[Step S401] The user interface 120 receives an input of an OS management number inquiry from the user 31.

[Step S402] The user interface 120 transmits, to the OS state monitoring unit 130, an OS management number obtaining request specifying an IP address indicated in the OS management number inquiry.

[Step S403] The OS state monitoring unit 130 transmits an OS management number reading request specifying the IP address to the OS information database 110.

[Step S404] The OS information database 110 reads an OS management number from a record including the specified IP address, and transmits the read OS management number to the OS state monitoring unit 130.

[Step S405] The OS state monitoring unit 130 transmits the obtained OS management number to the user interface 120.

[Step S406] The user interface 120 displays, on the monitor 21, the OS management number sent from the OS state monitoring unit 130 as a processing result corresponding to the OS management number inquiry.

The user 31 may thereby recognize the OS management number of an OS on which the software causing the problem is installed. When the user 31 then inputs a log obtaining instruction specifying the OS management number to the managing server 100, the encrypted file generation processing is performed.

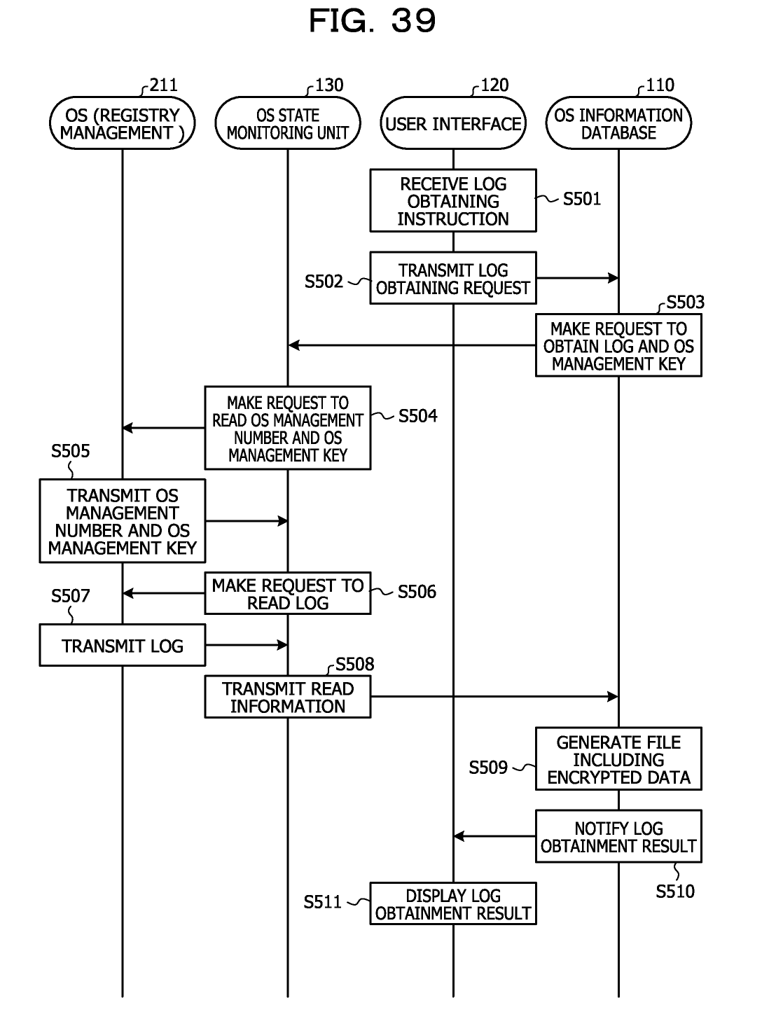

FIG. 39 is a flowchart illustrating an example of a procedure of encrypted file generation processing. The processing illustrated in FIG. 39 will be described in the following along step numbers.

[Step S501] The user interface 120 receives an input of a log obtaining instruction from the user 31.

[Step S502] The user interface 120 transmits a log obtaining request specifying the OS management number to the log managing unit 140.

[Step S503] The log managing unit 140 transmits a request to obtain a log and an OS management key, the request specifying the OS management number, to the OS state monitoring unit 130.

[Step S504] The OS state monitoring unit 130 transmits a request to read the OS management number and the OS management key to the OS 211 corresponding to the specified OS management number.

[Step S505] The OS 211 reads the OS management number and the OS management key from the registry 211a, and transmits the read OS management number and the read OS management key to the OS state monitoring unit 130.

[Step S506] The OS state monitoring unit 130 transmits a request to read the log 211c to the OS 211.

[Step S507] The OS 211 reads the log 211c, and transmits the read log 211c to the OS state monitoring unit 130.

[Step S508] The OS state monitoring unit 130 transmits the read OS management number, the read OS management key, and the read log 211c to the log managing unit 140.

[Step S509] The log managing unit 140 generates encrypted data by encrypting the OS management number, the OS management key, and the log 211c. The log managing unit 140 then generates a file including the generated encrypted data. The log managing unit 140 stores the generated file at a processing location.

[Step S510] The log managing unit 140 notifies a log obtainment result to the user interface 120.

[Step S511] The user interface 120 displays the log obtainment result on the monitor 21. For example, the storage location of the file including the encrypted OS management number, the encrypted OS management key, and the encrypted log 211c is displayed on the monitor 21.

At a time of a support request to the person 41 in charge of support, the user 31 notifies the OS management number and the content of the problem to the person 41 in charge of support, and sends the file including the encrypted log 211c to the person 41 in charge of support. The person 41 in charge of support determines, using the file received, whether or not the software having the problem is a target of a support contract.

Incidentally, while the person 41 in charge of support himself/herself determines whether or not the software having the problem is a target of a support contract in the example illustrated in FIGS. 18 to 22, the support contract managing server 300 may be made to make the determination. The following description will be made of a procedure of processing of determining whether or not the software having the problem is a support target (support contract confirmation processing), the processing being performed by the support contract managing server 300.

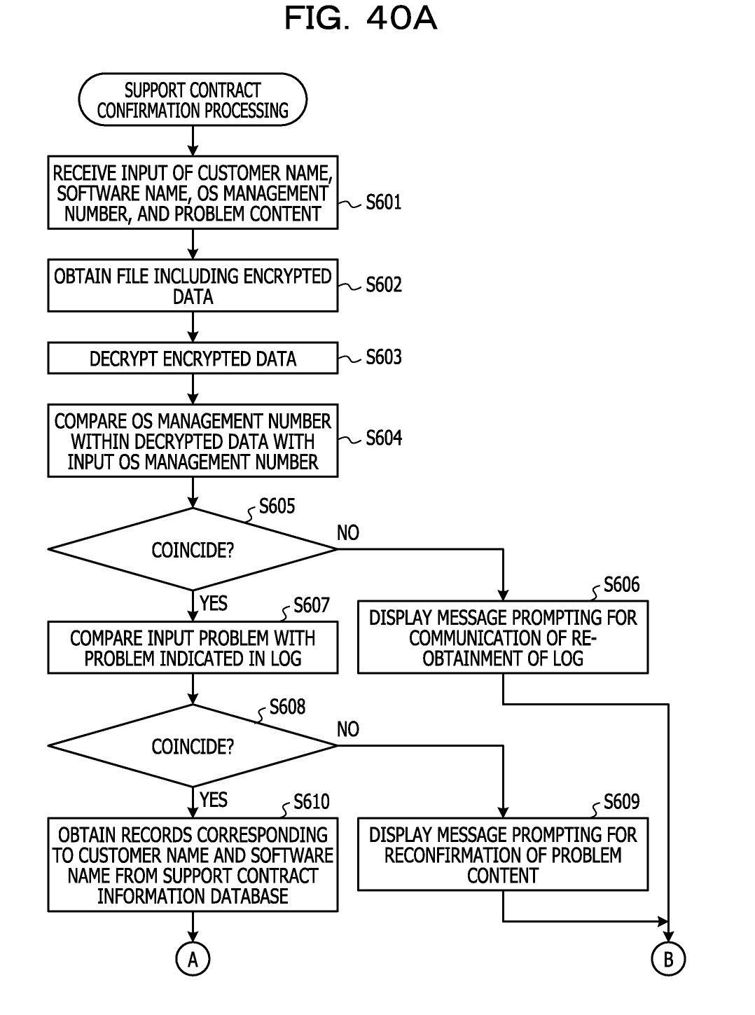

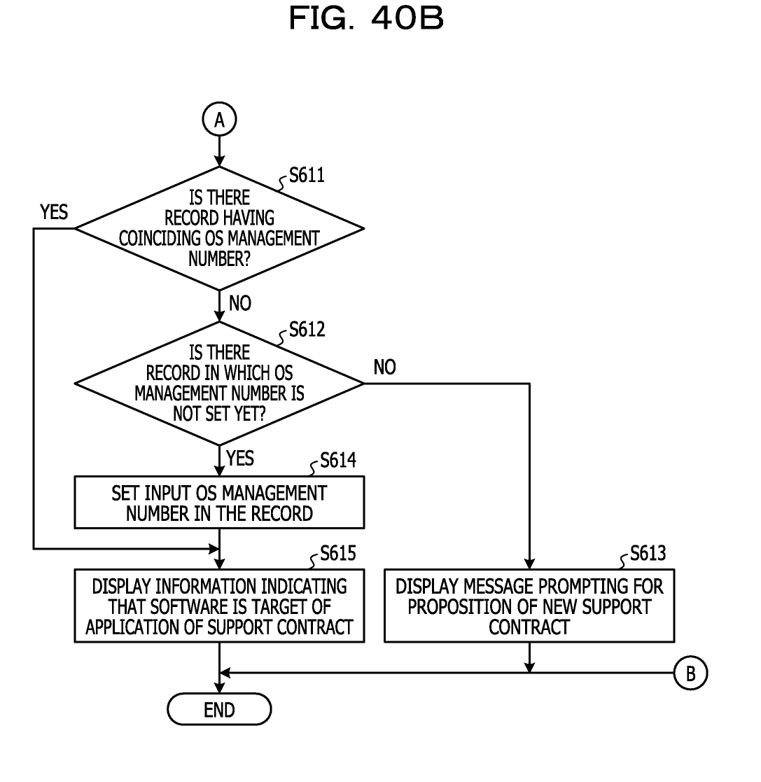

FIGS. 40A and 40B are a flowchart illustrating an example of a procedure of support contract confirmation processing. The processing illustrated in FIGS. 40A and 40B will be described in the following along step numbers.

[Step S601] The support contract managing unit 320 receives an input of a customer name, a software name, an OS management number, and a problem content. For example, the person 41 in charge of support inputs information such as the customer name and the like in given fields within a screen displayed by the support contract managing unit 320. As the OS management number and the problem content, information notified from the user 31 at the time of the support request is input. The problem content is, for example, an error code displayed at a time of occurrence of the problem. The support contract managing unit 320 obtains each piece of information input to the given fields.

[Step S602] The support contract managing unit 320 obtains a file including encrypted data. For example, the person 41 in charge of support stores the file within the storage device of the support contract managing server 300, and inputs a storage location of the file. The support contract managing unit 320 obtains the file from the input location.

[Step S603] The support contract managing unit 320 decrypts the encrypted data within the obtained file. An OS management number, an OS management key, and a log may be obtained by decrypting the encrypted data.

[Step S604] The support contract managing unit 320 compares the OS management number within the decrypted data with the OS management number input in step S601.

[Step S605] The support contract managing unit 320 determines whether or not the OS management numbers coincide with each other in the comparison of step S604. When the OS management numbers coincide with each other, the support contract managing unit 320 advances the processing to step S607. In addition, when the OS management numbers do not coincide with each other, the support contract managing unit 320 advances the processing to step S606.

[Step S606] The support contract managing unit 320 displays, on the monitor, a message prompting for communication of re-obtainment of a log. The person 41 in charge of support checks the displayed message, recognizes that an extraction source of the log received from the user 31 is incorrect, and requests the user 31 to re-obtain a correct log. The support contract confirmation processing is thereafter ended.

[Step S607] The support contract managing unit 320 compares the input problem content with a problem content indicated in the log. For example, the support contract managing unit 320 compares the error code indicating the problem content.

[Step S608] The support contract managing unit 320 determines whether or not the problem contents coincide with each other. When the problem contents coincide with each other, the support contract managing unit 320 advances the processing to step S610. In addition, when the problem contents do not coincide with each other, the support contract managing unit 320 advances the processing to step S609.

[Step S609] The support contract managing unit 320 displays, on the monitor, a message prompt for reconfirmation of the problem content. The person 41 in charge of support checks the displayed message, recognizes that the extraction source of the log received from the user 31 or the notified problem content is incorrect, and requests the user 31 to reconfirm the problem content. The support contract confirmation processing is thereafter ended.

[Step S610] The support contract managing unit 320 obtains records corresponding to a set of the input customer name and the input software name from the support contract information database 310.

[Step S611] The support contract managing unit 320 determines whether or not the obtained records include a record having an OS management number coinciding with the input OS management number. When there is such a record, the support contract managing unit 320 advances the processing to step S615. In addition, when there is no such record, the support contract managing unit 320 advances the processing to step S612.

[Step S612] The support contract managing unit 320 determines whether or not the obtained records include a record in which no OS management number is set yet. When there is such a record, the support contract managing unit 320 advances the processing to step S614. In addition, when there is no such record, the support contract managing unit 320 advances the processing to step S613.

[Step S613] The support contract managing unit 320 displays, on the monitor, a message prompting for proposition of a new support contract. The person 41 in charge of support recognizes by checking the displayed message that the number of pieces of software as targets of support contracts is insufficient, and proposes a new support contract to the user 31. The support contract confirmation processing is thereafter ended.

[Step S614] The support contract managing unit 320 sets the input OS management number in one record in which no OS management number is set yet among the obtained records. The support contract managing unit 320 writes back the record in which the OS management number is set to the support contract information database 310.

[Step S615] The support contract managing unit 320 displays, on the monitor, information indicating that the software as a target of support based on the support request is a target of application of a support contract. The person 41 in charge of support checks the display indicating that the software is a target of application of a support contract, and performs support for the user 31. The support contract confirmation processing is thereafter ended.

Thus, according to the second embodiment, even when software is installed on a virtual machine, the individual software may be identified, and associated with a support contract. As a result, when the user 31 requests support from the person 41 in charge of support, the person 41 in charge of support may determine whether the contents of the inquiry of the user are correct, and respond appropriately.

Further, even when a virtual machine is copied, the managing server 100 may recognize that OSes operating on the respective virtual machines as a copy source and a copy destination are different individual OSes, and assign OS management numbers to the respective OSes. Thus, even when a virtual machine is copied, it is possible to suppress support from being performed for both of pieces of software as a copy source and a copy destination with a support contract for one piece of software.

### Other Embodiments

In the example illustrated in FIG. 17 in the second embodiment, the user 31 separately inputs an inquiry about an OS management number and an instruction to obtain a log of an OS. However, these inputs may also be completed at a time. For example, the user 31 inputs a log obtaining instruction specifying the IP address of the OS. The user interface 120 receives the log obtaining instruction, and transmits a log obtaining request specifying the IP address to the log managing unit 140. The log managing unit 140 transmits, to the OS state monitoring unit 130, a request to obtain an OS management number, an OS management key, and a log, the request specifying the IP address. The OS state monitoring unit 130 obtains the OS management number and the OS management key from the registry of the OS corresponding to the IP address. In addition, the OS state monitoring unit 130 obtains the log of software from the OS corresponding to the IP address. The OS state monitoring unit 130 transmits the obtained OS management number, the obtained OS management key, and the obtained log to the log managing unit 140. The log managing unit 140 encrypts the obtained OS management number, the obtained OS management key, and the obtained log, and generates a file including the encrypted data. The log managing unit 140 then transmits a response of log obtainment completion to the user interface 120. The user interface 120 displays, on the monitor 21, information indicating that the storing of the file including the log is completed. It is thus possible to reduce the labor of input of the user 31 at a time of generating the encrypted data including the log.

Incidentally, while an IP address is used as information identifying an OS on the network in the second embodiment, an OS may be identified by other information. For example, in a case where an individual identification number is set to an OS, the OS may be identified by the individual identification number.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system configured to manage a computer executing a first operating system, the information processing system comprising:
at least one memory; and
at least one processor coupled to the at least one memory and configured to:
receive a request signal that requests information related to software installed on the first operating system;
obtain, from the first operating system, in response to the request signal, a log of a message generated in execution of the software and a first identifier identifying the first operating system;
obtain a second identifier for identifying a second operating system on which support target software of a support contract is installed;
execute a first determination which determines whether the first identifier and the second identifier coincide with each other;
execute a second determination which determines whether the message indicates occurrence of a failure based on the log; and
determine whether support for the software is included in a scope of the support contract based on a result of the first determination and a result of the second determination.

2. The information processing system according to claim 1, the information processing system comprising:
at least two memories and at least two processors;
a first information processing device including a first memory of the at least two memories and a first processor of the at least two processors coupled to the first memory; and
a second information processing device including a second memory of the at least two memories and a second processor of the at least two processors coupled to the second memory, wherein
the first processor is configured to:
receive the request signal;
obtain, from the first operating system in response to the request signal, the log of the message and the first identifier; and
transmit the log and the first identifier to the second information processing device, and
the second processor is configured to:
receive the log and the first identifier; and
obtain the second identifier in response to the received log and the received first identifier.

3. The information processing system according to claim 2, wherein
the first processor is configured to:
generate encrypted data obtained by encrypting the log and the first identifier; and
transmit the encrypted data to the second information processing device, and
the second processor is configured to:
obtain the log and the first identifier by decrypting the encrypted data.

4. The information processing system according to claim 2, wherein
the first processor is configured to:
generate the first identifier; and
store the first identifier in a storage area of setting information of the first operating system in the first memory.

5. The information processing system according to claim 2, wherein
the second processor is configured to:
determine that the support for the software is included in the scope of application of the support contract when the first identifier and the second identifier coincide with each other and the message indicates the occurrence of the failure.

6. The information processing system according to claim 2, wherein
the second processor is configured to:
store, in the second memory, second identifiers equal in number to or less in number than the number of pieces of support target software defined in the support contract;
determine whether the number of the second identifiers stored in the second memory reaches the number of pieces of support target software when no second identifier coinciding with the first identifier is stored in the second memory;
store the first identifier as the second identifier in the second memory when the number of the second identifiers stored in the second memory is less than the number of pieces of support target software, and
determine that the second identifier and the first identifier coincide with each other.

7. The information processing system according to claim 2, wherein
the first information processing device is coupled to the computer by a local area network, and
the second information processing device is coupled to the first information processing device by a wide area network.

8. A method using a processing system configured to manage a computer executing a first operating system, the method comprising:
receiving a request signal that requests information related to software installed on the first operating system;
obtaining, from the first operating system in response to the request signal, a log of a message generated in execution of the software and a first identifier identifying the first operating system;
obtaining a second identifier for identifying a second operating system on which support target software of a support contract is installed;
executing a first determination which determines whether the first identifier and the second identifier coincide with each other;
executing a second determination which determines whether the message indicates occurrence of a failure based on the log; and
determining whether support for the software is included in a scope of the support contract based on a result of the first determination and a result of the second determination.

9. The method according to claim 8, wherein the information processing system includes:
a first information processing device including a first memory and a first processor coupled to the first memory; and
a second information processing device including a second memory and a second processor coupled to the second memory, wherein
the receiving of the request signal, the obtaining of the log of the message and the first identifier, and the transmitting of the log and the first identifier to the second information processing device are executed by the first processor, and
the receiving of the log and the first identifier, and the obtaining of the second identifier are executed by the second processor.

10. The method according to claim 9, further comprising:
generating encrypted data obtained by encrypting the log and the first identifier; and
obtaining the log and the first identifier by decrypting the encrypted data.

11. The method according to claim 10, wherein:
the generating of the encrypted data and the transmitting of the encrypted data to the second information processing device are executed by the first processor, and
the obtaining of the log and the first identifier is executed by the second processor.

12. The method according to claim 9, further comprising:
generating the first identifier; and
storing the first identifier in a storage area of setting information of the first operating system in the first memory.

13. The method according to claim 9, further comprising:
determining that the support for the software is included in the scope of application of the support contract when the first identifier and the second identifier coincide with each other and the message indicates the occurrence of the failure.

14. The method according to claim 9, further comprising
storing, in the second memory, second identifiers equal in number to or less in number than the number of pieces of support target software defined in the support contract;
determining whether the number of the second identifiers stored in the second memory reaches the number of pieces of support target software when no second identifier coinciding with the first identifier is stored in the second memory;
storing the first identifier as the second identifier in the second memory when the number of the second identifiers stored in the second memory is less than the number of pieces of support target software; and
determining that the second identifier and the first identifier coincide with each other.

15. The method according to claim 9, wherein
the first information processing device is coupled to the computer by a local area network, and
the second information processing device is coupled to the first information processing device by a wide area network.

16. A non-transitory computer-readable storage medium storing a program that causes an information processing apparatus to execute a process, the information processing apparatus configured to manage a computer executing a first operating system, the process comprising:
receiving a request signal that requests information related to software installed on the first operating system;
obtaining, from the first operating system in response to the request signal, a log of a message generated in execution of the software and a first identifier identifying the first operating system;
obtaining a second identifier for identifying a second operating system on which support target software of a support contract is installed;
executing a first determination which determines whether the first identifier and the second identifier coincide with each other;
executing a second determination which determines whether the message indicates occurrence of a failure based on the log; and
determining whether support for the software is included in a scope of the support contract based on a result of the first determination and a result of the second determination.

17. The non-transitory computer-readable storage medium according to claim 15, wherein the information processing system includes:
a first information processing device including a first memory and a first processor coupled to the first memory; and
a second information processing device including a second memory and a second processor coupled to the second memory, and
wherein
the receiving of the request signal, the obtaining of the log of the message and the first identifier, and the transmitting of the log and the first identifier to the second information processing device are executed by the first processor, and
the receiving of the log and the first identifier, and the obtaining of the second identifier are executed by the second processor.

18. The non-transitory computer-readable storage medium according to claim 17, the process further comprising:
generating encrypted data obtained by encrypting the log and the first identifier; and
obtaining the log and the first identifier by decrypting the encrypted data.

19. The non-transitory computer-readable storage medium according to claim 18, wherein:
the generating of the encrypted data and the transmitting of the encrypted data to the second information processing device are executed by the first processor, and
the obtaining of the log and the first identifier is executed by the second processor.

20. The non-transitory computer-readable storage medium according to claim 17, the process further comprising:
generating the first identifier; and
storing the first identifier in a storage area of setting information of the first operating system in the first memory.
